(19) United States
(12) Patent Application Publication
(10) Pub. No.: US 2014/0182232 A1
(43) Pub. Date: Jul. 3, 2014

(54) COMPOSITE OPEN/SPACED MATRIX COMPOSITE SUPPORT STRUCTURES AND METHODS OF MAKING AND USING THEREOF

(71) Applicant: Drew Ryan Holt, Minneapolis, MN (US)

(72) Inventor: Drew Ryan Holt, Minneapolis, MN (US)

(21) Appl. No.: 14/118,390

(22) PCT Filed: May 18, 2012
(86) PCT No.: PCT/US12/38614

§ 371 Date: Nov. 18, 2013

Related U.S. Application Data
(60) Provisional application No. 61/488,041, filed on May 19, 2011.

(51) Int. Cl. E04C 3/36; B29C 70/56

(52) U.S. Cl. CPC E04C 3/36; B29C 70/56
USPC 52/645; 52/660; 156/433; 156/175

(57) ABSTRACT

A lattice support structure or tower comprising one or more open matrix composite strut members connecting a series of interlocking connectors to create a ridged support platform for telecommunications, surveillance, renewable energy, lighting and energy transmission applications. Embodiments of the invention are telescoping for ease of transport and erection. The erection and deployment can be achieved through means of automatic deployment or manual.

### CROSS-REFERENCE TO RELATED APPLICATION

This application claims priority to U.S. Provisional Application No. 61/488,041 filed on May 19, 2011, the contents of which are incorporated by reference herein.

### FIELD OF THE INVENTION

The present invention is related to lattice support structures used in the technical field of rapid deployable tower and mast systems. In various embodiments, the lattice structures of the present invention are produced and used in the technical fields including, but not limited to, renewable energy power production, energy/power transmission, communications, surveillance, lighting, containment fencing, and antenna support.

### BACKGROUND OF THE INVENTION

Conventional telecommunications and renewable energy production support structures are constructed of wood, steel (e.g. galvanized, stainless and painted steel . . . ) aluminum, and reinforced concrete. Such structures are exceedingly difficult to transport and very difficult to disassemble and move once installed. It is difficult to move these devices cost effectively in the field due to the structured and inherent high density and cumbersome nature. Moving such devices typically requires substantially constructed roads for transportation of construction equipment namely but not limited to earth moving equipment, concrete trucks for foundations, and erection cranes. Further, it is not uncommon that road construction to the construction/erection site is a majority of overall project cost. Further, the support structures are extremely difficult, dangerous and costly to transport erect and commission on rooftops and in remote locations.

Furthermore, structural supports, including three-dimensional composite lattice-type structural supports, have been developed for many applications which necessarily provide high strength performances, but benefit from the presence of less material. In other words, efficient structural supports can possess high strength, and at the same time, be low in weight resulting in high strength/weight ratios. Three-dimensional composite and standard materials truss systems have been pursued for many years and continue to be studied and redesigned by engineers with incremental improvements.

In the field of carbon fiber lattice support structures, the primary definition of such systems relates to the definition of three-dimensional systems currently in use. Further, it relates to the construction of joints in said systems coupling members of the system together forming a single larger unit. Approaches to coupling the lattice members such as weaving, twisting, mechanical fastening, bypassing of nodes, or the like have been used in three-dimensional structures where at least one joining member protrudes from a standard 2-D Cartesian plane to form a 3-D structure whether bending or protruding in a linear fashion. Thus, it would be desirable to provide a lattice support structure that is two-dimensional in nature, versatile in shape, confined to a single Cartesian plane using fiber-based materials and incredibly strong and stable in supporting desired objects at the peak of such a structure. The industry still searches for a support structure that is lightweight, easily installable, consistently durable, structurally stable and provides pleasant aesthetics.

### SUMMARY OF THE INVENTION

The present invention is of open lattice composite matrix support structures comprising a plurality of filaments or fibers layered in a interweaved configuration that intersect at a plurality of nodes and are set into a stabilized position by embedding them within one or more cured polymeric materials. Various embodiments of the open/spaced matrix composite support structures of the present invention are of a telescoping and/or collapsible design that allow such support structures to be compact for cost effective transport and rapidly deployed due to their ultra light yet very strong structure. The composite support structures of the present invention are generally light weight, durable and provide a stable and effective structure that can replace pole or mast systems made from much heavier materials such as wood, steel, aluminum, reinforced concrete and the like.

The advantages of the present invention include, without limitation, that it is portable and exceedingly easy to transport with a low cost to install due to the open matrix composite strut material that has an exceedingly high strength to weight ratio. Furthermore, it is easy to move these devices in the field because or there dramatically reduced weight versus towers and poles made from heavier materials, such as metals or woods. Moving such devices typically requires man power and small tools with a potential for medium duty construction equipment. Further, the devices generally can be field deployed without the need to build approved roads, the need and use poured concrete and/or the use of heavy cranes for installation.

In broad embodiment, the present invention is a lattice structure (e.g. static or telescoping tower) of any open lattice composite, thereby providing reduced mass, installation ease and cost reduction.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIGS. 1A-1F depict nodal variations and alternatives possible in two-dimensions where all members are constrained to two Cartesian Coordinates;

FIGS. 2A-2B depict exemplary embodiments in rectangular form of the two-dimensional lattice support structure in accordance with embodiments of the present disclosure;

FIG. 3 depicts alternative exemplary embodiments of the cross members in the two-dimensional lattice support structures in accordance with embodiments of the present disclosure;

FIGS. 4A-4B depict alternative exemplary embodiments of the two-dimensional lattice support structures highlighting alternative symmetrical shapes and versatility in cross member design in accordance with embodiments of the present disclosure;

FIGS. 5A-5F depict alternative exemplary embodiments of the two-dimensional lattice support structure with various arrangements of cross members, border members, laterals and longitudinal members including all possible nodal configurations between border members in accordance with embodiments of the present disclosure;

FIG. 6 depicts another exemplary arrangement of the two-dimensional lattice support structure in accordance with embodiments of the present disclosure;

FIG. 7 depicts another exemplary arrangement of the two-dimensional lattice support structure demonstrating versatility in structure design in the two-dimensional plane in accordance with embodiments of the present disclosure;

FIG. 8 depicts another exemplary arrangement of the two-dimensional lattice support structure demonstrating versatility in structure design in the two-dimensional plane in accordance with embodiments of the present disclosure;

FIG. 9 depicts the primary mandrel tool used to manufacture the two-dimensional lattice structure including grooves forming the desired pattern of the final product in accordance with embodiments of the present disclosure; and

FIG. 10, depicts the primary mandrel tool as combined with a layer of silicone or other similar material and another hard surface to apply pressure on the unit while curing in accordance with embodiments of the present disclosure.

FIG. 11 depicts an embodiment of an expandable tool including an actuator cam system in a preloaded position;

FIG. 12 depicts an embodiment of an expandable tool including an actuator cam system in an outward extended loaded position for full fiber tension prior to cure; NOTE: air gap between plates;

FIG. 13 depicts an embodiment of an expandable tool including an actuator cam system in a collapsed position;

FIG. 14 depicts a sectional perspective view of an expanding/tensioning mandrel core in a pre-load configuration;

FIG. 15 depicts a sectional perspective view of an expandable mandrel in a collapsed configuration;

FIG. 16 depicts an embodiment of an expandable tool including a circular motion mandrel core in a preloaded position;

FIG. 17 depicts an embodiment of an expandable tool including a circular motion mandrel core in an outward extended loaded position for full fiber tension prior to cure; NOTE: air gap between plates;

FIG. 18 depicts an embodiment of an expandable tool including a circular motion mandrel core in a collapsed position;

FIG. 19 is a side view of two cylindrical patterned strut sections that include a nested connection section;

FIG. 20 is a side view of three cylindrical patterned strut sections that include a nested connection section;

FIG. 21 is a perspective view of one embodiment of a trapezoidal strut section;

FIG. 22a is a perspective view of another embodiment of a trapezoidal strut section;

FIG. 22b is a side view of another embodiment of a trapezoidal strut section;

FIG. 23a is a side view of one embodiment of an octagonal strut section including square patterns;

FIG. 23b is a perspective view of one embodiment of an octagonal strut section including diamond patterns;

FIG. 24 is a side view of another embodiment of a strut section including diamond patterns;

FIG. 25 is a top view of an embodiment of a hexagonal strut section that includes support members;

FIG. 26a is a perspective view of an embodiment of a hexagonal strut section that includes support members;

FIG. 26b is a top perspective view of one embodiment of a hexagonal strut section that includes diamond patters;

FIG. 26c is a side view of one embodiment of a hexagonal strut section;

FIG. 27 is a side view of one embodiment of a triangular strut section;

FIG. 28 is a side view of one embodiment of a plurality of interlocking triangular strut sections to form a column;

FIG. 29 is a perspective side view of one embodiment of a plurality of interlocking octagonal strut sections to form a column;

FIG. 30 is a perspective side view of one embodiment of a plurality of interlocking hexagonal strut sections to form a column;

FIG. 31 is a side view of one embodiment of a plurality of interlocking trapezoidal strut sections to form an octagonal column;

FIG. 32 is a side view of one embodiment of a plurality of interlocking strut sections mechanically connected with a cable system to form a column;

FIG. 33 is a side view of one embodiment of a plurality of interlocking trapezoidal strut sections mechanically connected with a cable system to form a column;

FIG. 34 is a perspective view of a rapid deploy telescoping tower formed from trapezoidal struts;

FIG. 35 is a perspective view of a rapid deploy telescoping tower formed from cylindrical struts;

FIG. 36 is a side view of a telescoping tower cable actuated self erecting pulley mechanism;

FIG. 37 is another side view of a telescoping tower cable actuated self erecting pulley mechanism;

FIG. 38 is a side view of a pneumatic pump system for self erection of one embodiment of a telescoping tower;

FIG. 39 is a side view of a pneumatic, hydraulic or mechanical screw jack erection system for deploying one embodiment of a telescoping tower;

FIG. 40 is a perspective side view of an interlocking connector in a multi-strut lattice structure that includes locking pins;

FIG. 41 is a perspective side view of an interlocking connector in a multi-strut lattice structure that includes locking pins;

FIG. 42 is a transparent perspective view of a 45 deg. quick lock threaded connector for heavy load applications in multi-strut lattice structures;

FIG. 43 is a side view of a 45 deg. quick lock threaded connector for heavy load applications connecting strut sections in a multi-strut lattice structure;

FIG. 44 is a side exploded view of a single lug (debris) friendly 45 deg. quick lock connector for connecting strut sections in a multi-strut lattice structure;

FIG. 45 is a side view of a quick lock connector for connecting strut sections in a multi-strut lattice structure;

FIG. 46 is a side view of a telescoping connector to strut interface;

FIG. 47 is a side view of a tapered connector assembly;

FIG. 48 is a side view of an expandable lug connector assembly;

FIG. 49 is a perspective view of an expandable lug connector assembly;

FIG. 50 is a side view of an expandable lug connector assembly including the helical slit for expansion;

FIG. 51 is a side view of a lattice structure connected to a T-bar swivel base;

FIG. 52 is a side view of a lattice structure connected to a T-bar swivel base wherein the tower is in a collapsed state;

FIG. 53 is a perspective view of a T-bar swivel base;

FIG. 54 is a perspective view of a lattice structure connected to a connecter adapted for a T-bar swivel base;

FIG. 55 is a side view of a lattice structure connected to a two-piece flange mount extension;

FIG. 56 is a side view of a helical pier used for the base foundation instead of concrete;

FIG. 57 is a perspective view of a helical pier adjoined to a swivel base;

FIG. 58 is a perspective view of a helical pier including a tapered hinge mount;

FIG. 59 is a perspective view of a helical pier including a tapered hinge mount in an open position;

FIG. 60 is a perspective view of a power pole lattice structure including a helical pier;

FIG. 61 is a perspective view of a solar panel mount in combination with a communications dish;

FIG. 62 is a side view of a solar panel mount;

FIG. 63 is a side view of a solar panel mount in combination with a communications dish;

FIG. 64 is a side view of satellite and microwave dishes attached to a lattice tower;

FIG. 65 is side view of a satellite and surveillance camera package on a rapid deploy tower;

FIG. 66 is a side view of a power block and camera attached to an rapid deploy tower;

FIG. 67 is side view of a satellite antenna attached to rapid deploy tower;

FIG. 68 is a side view of duel communications dishes attached to a rapid deploy tower; and

FIG. 69 is a turbine system attached to an embodiment of a rapid deploy tower.

Reference will now be made to the exemplary embodiments illustrated, and specific language will be used herein to describe the same. It will nevertheless be understood that no limitation of the scope of the invention is thereby intended.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

Referring now to the invention in more detail, the open lattice composite matrix support structures of the present invention include a plurality of fiber/polymer members (e.g. fiber/polymer strands, tapes, strings . . . ), including a plurality of filaments or fibers layered in an interweaved configuration that intersect at a plurality of nodes. The filaments or fibers of the composite members are set into a stabilized position by embedding them within one or more cured polymeric materials. Furthermore, in various embodiments of the present invention, the fiber/polymer composite is cured while placed within channels on an expandable manufacturing apparatus (e.g. an expandable mandrel). In other embodiments the apparatus may support the composite members without channels through point to point locations raised above the mandrel surface suspending the fibers in atmosphere under tension. The expandable apparatus may be expanded to apply pressure from within the lattice structure outward prior to curing the polymers, thereby administering an outward expansion pressure to the fiber-polymer composite. Once outward pressure is applied the polymeric materials are cured with radiation or other crosslinking agents, thereby forming the lattice structure of the present invention. It has been found that the outward pressure exerted upon the filaments or fibers preloads the fibers within the polymer encasing and facilitates the straightening of the filaments/fibers, thereby producing a tension of the filaments/fibers that creates additional strength and stability in the fiber/polymer composite upon curing. In other embodiments, pressure may be applied during the curing process using rotational centrifugal force. In yet other embodiments, pressure may be applied to the composite members through the closing of an enclosure (e.g. a clam-shell enclosure) through solid mechanical pressure applied around the fiber/polymer composite and mandrel.

Turning now to more specific detail regarding consolidation of the multi-layered nodes, it has been recognized that the closer the fibers are held together, the more they act in unison as a single piece rather than a group of fibers. In composites, resin can facilitate holding the fibers in close proximity of each other both in the segments of the cross supports themselves, and at the multi-layered nodes when more than one directional path is being taken by groups of unidirectional fibers layered in the Cartesian two-dimensional plane. In filament winding systems of the present disclosure, composite tow or tape (or other shaped filaments) can be wound and shaped using a solid mandrel (e.g. an outward expanding mandrel as described below), and then the composite fibers forced together using a consolidating force, such as pressure. Under this force (e.g. pressure), one or more curing and/or crosslinking agent(s) or technique(s) (e.g. applying radiation or a crosslinking agent) can be used to fuse the multi-layered nodes, generating a tightly consolidated multi-layered node. Thus, in various embodiments, the multi-layered node is held in place tightly using pressure, and under pressure, the multi-layered node (including the filament or tow material and the resin) can be fused or cured, in some embodiments with radiation and/or crosslinking agents, making the multi-layered node more highly compacted and consolidated than other systems.

Further, by using a rigid mandrel with specifically cut paths for the unidirectional fiber to be laid into, the multi-layered nodes are held tight during the consolidation process. Conventional industry-standard bags, polyurea-based products or other bagging materials placed over the fibers can act as a pressure medium, pushing the fibers into the grooves of the solid mandrel and removing any voids which may occur by other methods. Additionally, outward pressure using an expandable mandrel as describe below has been found to provide beneficial fiber/polymer consolidating results. Further, the use of a silicate or flexible material layer sandwiched between two solid parts will also provide the force or pressure needed to achieve complete consolidation. As a result, high levels of consolidation (90-100% or even 98-100%) can be achieved. In other words, porosity of the consolidated material providing voids and weak spots in the structure are virtually eliminated. In short, consolidation control using a rigid mandrel, consolidating force (e.g. pressure) over the wound filament or fibers and resin/curing and/or crosslinking (e.g. with heat) provides high levels of consolidation that strengthen the lattice as a whole.

In addition, there are other advantages of the system described herein, namely the ability to manipulate the cross-sectional geometry of the cross sectional shape of the individual cross supports. As a function of the solid mandrel and the silicone or other similar materials, forcing the fibers into the cut grooves allows for the geometry of the cross supports to be modified in cross section. Any geometry which can be applied to the mandrel and/or the grooves of the rigid mandrel can be used to shape resulting lattice supports and can range from square/rectangular to triangular, half-pipe, or even more creative shapes such as T-shape cross sections. This provides the ability to control or manipulate the moment of inertia of the cross support members. For example, the difference in inertial moments of a flat unit of about 0.005″ thickness and a T-shaped unit of the same amount of material can reach up to and beyond a factor of 200. With the use of a solid mandrel, outward pressure application, and resin/radiation curing, measurement has shown that geometric tolerances can be kept at less than 0.5%.

The open lattice composite matrix support structures of the present invention, (e.g. towers, masts . . . ) may be made of any fiber reinforced polymer composites. Open matrix structural strut members, such as those depicted in the figures identified herein, may be manufactured using any variation of filaments or fibers, such as carbon, glass, basal, plastic, aramid or any other reinforcement fiber. In various embodiments, the composite may contain other fibers, such as Kevlar®, aluminum, S-Glass, E-Glass or other glass fibers. The previously identified fibers may be used alone or in combination with one another. For example, fibers formed from Kevlar®, aluminum or glass may be used in conjunction with carbon fibers.

Additionally, the open lattice composite matrix support structures of the present invention utilize various polymers in conjunction with the filaments or fibers to form the composites. In operation, the filaments or fibers are embedded within one or more polymers to form the lattice structures. For example, polymers or resins of epoxy, urethane, thermoplastics (e.g. polypropylene, polyethylene, polycarbonates, PES, PEI, PPS, PEEK, and PEK . . . ), polystyrene, ABS, SAN, polysulfone, polyester, polyphenylene sulfide, polyetherimide, polyetheretherketone, ETFE and PFA fluorocarbons, polyethylene terephthalate (PET), vinyl esters and nylons. In various beneficial embodiments, the polymers or resins are not cured with heat or similar thermal radiation, but are non-heat radiation cured resin systems cured using radiations including Ultraviolet (UV), Infrared (IR), Electron Beam (EB or E-beam) or X-ray. Alternatively, other crosslinking sources may be used during curing, such as chemical curing agents, or other methods for crosslinking resins may be implemented. For example, radiation cured resins (e.g. resins cured with UV, IR, E-beam or X-ray) that may be used in the fiber/polymer composites of the present invention include, but are not limited to, bisphenol A epoxy diacrylates, such as Ebecryl® 3700-20H, Ebecryl® 3700-20T, Ebecryl® 3700-25R, Ebecryl® 3720, Ebecryl® 3720-TP25, and Ebecryl® 3700, all commercialized and available through Cytec Industries, Inc. It is noted that the Ebecryl® commercially available radiation cured resins are diacrylate esters of a bisphenol A epoxy and, in some of the Ebecryl® products, the bisphenol A epoxy diacrylates are diluted with the reactive diluent tripropylene glycol diacrylate. Further, the various components of the lattice structures (e.g. towers, masts . . . ) can be made of different polymers or other materials (e.g. metals, woods, ceramics . . . ).

As previously suggested, composite members are interweaved and intersect at various nodes throughout the lattice structures of the present invention. To properly describe embodiments of the present disclosure, the following terms are defined and used consistently in the figures:
1. Composite Member: The composite member is the generic term used to identify any of the members used to form the open lattice composite matrix support structures, such as the primary border member, secondary border member, longitudinal member, lateral member and cross member.
2. Primary Border Member, [21]: In the present disclosure, there must always be at least two primary border members running the same direction in the same Cartesian plane. They may differ in shape but their shape defines two exterior sides of the unit. They can be touching at the ends, thus eliminating the need for any Secondary Border Members.
3. Secondary Border Member, [22]: This member type connects the ends of the Primary Border Members when they are connected end-to-end themselves. This is an optional member in the unit design. When no other lateral members are present, a secondary border member would count for the required lateral member in the structure.
4. Longitudinal Member, [11]: An optional member running the length of the Primary Border Members.
5. Lateral Member, [12]: One or more of these members are required to bridge between the Primary Border Members.
6. Cross Member, [13]: Optional diagonal members running between Primary Border Members, Secondary Border Members, Laterals and/or Longitudinals.
7. Primary Isogrid Node, [14]: A node comprised of at least two of Primary Border Members, Secondary Border Members, Longitudinal Members and/or Lateral Members coupled with at least two Cross Members.
8. Secondary Isogrid Node, [15]: A node comprised of at least two of Primary Border Members, Secondary Border Members, Longitudinal Members and/or Lateral Members.
9. Tertiary Isogrid Node, [16]: A node comprised of one Primary Border Member, Secondary Border Member, Longitudinal Member or Lateral Member coupled with at least two Cross Members.
10. Primary Anisogrid Node, [17]: A node comprised of one Primary Border Member, Secondary Border Member, Longitudinal Member or Lateral Member coupled with one Cross Member.
11. Secondary Anisogrid Node, [18]: Two or more Cross Members coupled together without any Primary Border Members, Secondary Border Members, Longitudinal Members and/or Lateral Members.

In accordance with the definitions above, a two-dimensional lattice support structure as disclosed in this invention comprises at least two border members defining the geometry of the final product. Ingrained in and extant between these border members exists a plurality of fiber/polymer based cross members, lateral members and longitudinal members intersecting one another to form multi-layered nodes in a single Cartesian plane. The multi-layered nodes and consequential structural members can be consolidated within a groove of a rigid mold in the presence of resin, one or more curing and/or crosslinking agent(s) or techniques (e.g. applying radiation or a resin crosslinking agent or technique, such as crosslinking chemicals), and a consolidating force (e.g. applying outward pressure).

In another embodiment, a two-dimensional lattice support structure as disclosed in this invention comprises at least two border members defining the geometry of the final product. Ingrained in and extant between these border members exists a plurality of fiber-based cross members, lateral members and longitudinal members intersecting one another to form multi-layered nodes in a single Cartesian plane. The resulting multi-layered nodes can comprise at least two layers of the first cross support separated by a least one layer of the second cross support. Additionally, at least one of the first cross support or the second cross support can be curved from node to node in a single Cartesian plane.

In further detail with respect to these embodiments, several figures provided herein setting forth additional features of the lattice support structures of the present disclosure.

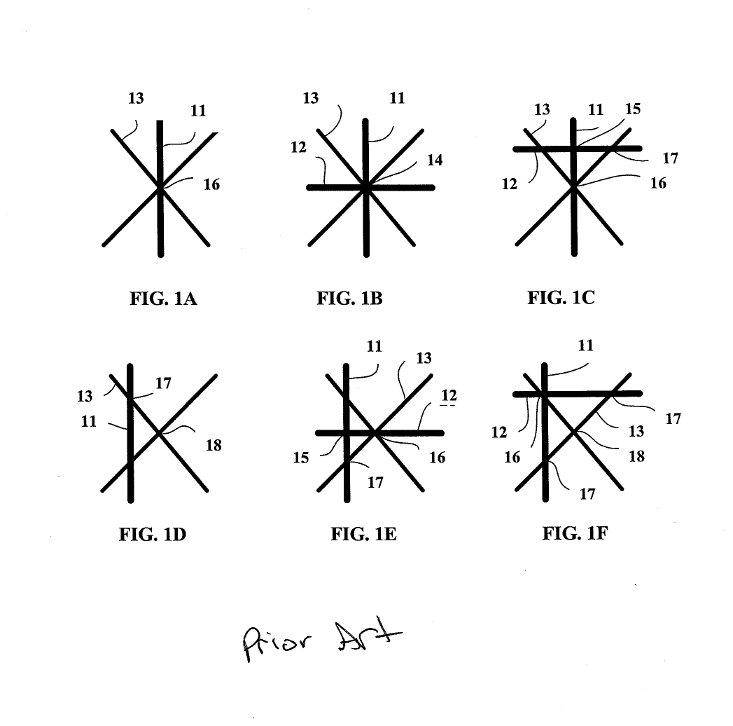

With specific reference to FIGS. 1A-1F, various configurations that are known in the art of crossing structural members to form isogrid and anisogrid nodes between border members is demonstrated. FIG. 1A depicts a basic node comprising a longitudinal member, 11, coupled with two cross members, 13, to form an isogrid tertiary node, 16, comprised of either a longitudinal or lateral structural member and two cross members. FIG. 1B depicts a primary isogrid node comprising both a longitudinal, 11, and a lateral, 12, structural member crossing each other with two cross members, 13, crossing at the same point forming the heaviest possible isogrid node. FIG. 1C depicts three node types, a secondary isogrid node, 15, where longitudinal, 11, and lateral, 12, structure members cross each other, a tertiary isogrid node, 16, where a longitudinal, 11, structure member is crossed by two cross members, 13, and a primary anisogrid node, 17, where a lateral, 12, structure member is crossed with one cross member, 13. FIG. 1D depicts a primary anisogrid node, 17, where a longitudinal, 11, structure member is crossed with one cross member, 13 and a secondary anisogrid node where two cross members, 13, cross each other. FIG. 1E depicts three node types, a secondary isogrid node, 15, where longitudinal, 11, and lateral, 12, structure members cross each other, a tertiary isogrid node, 16, where a lateral, 12, structure member is crossed by two cross members, 13, and a primary anisogrid node, 17, where a lateral, 12, structure member is crossed with one cross member, 13. FIG. 1F depicts three node types, a tertiary isogrid node, 16, where a longitudinal, 11, and a lateral, 12, cross in concert with a single cross member, 13, and a primary anisogrid node, 17, where a lateral, 12, structure member is crossed with one cross member, 13, and a secondary anisogrid node, 18, where two cross members, 13, cross.

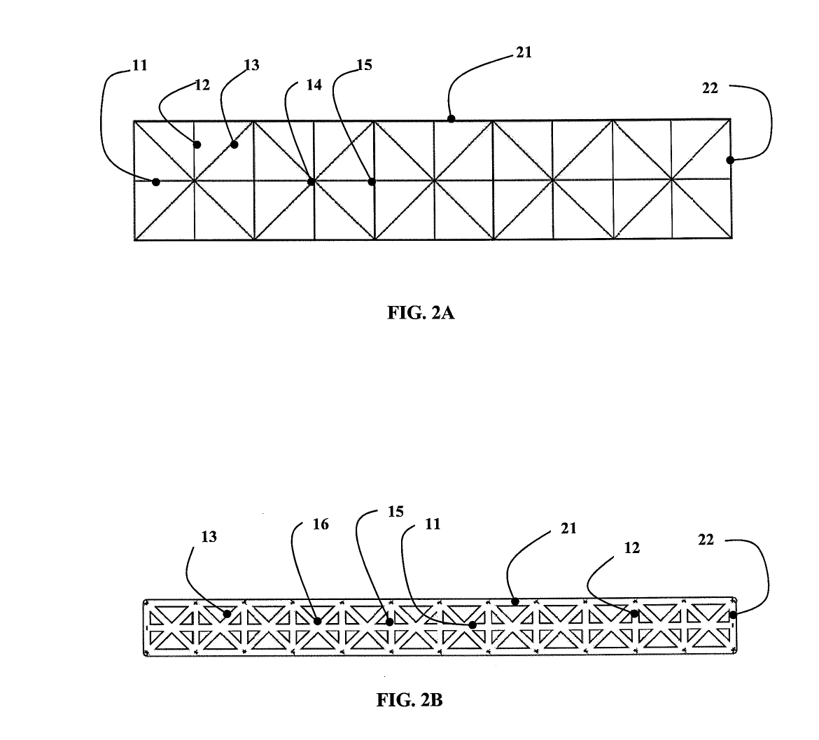

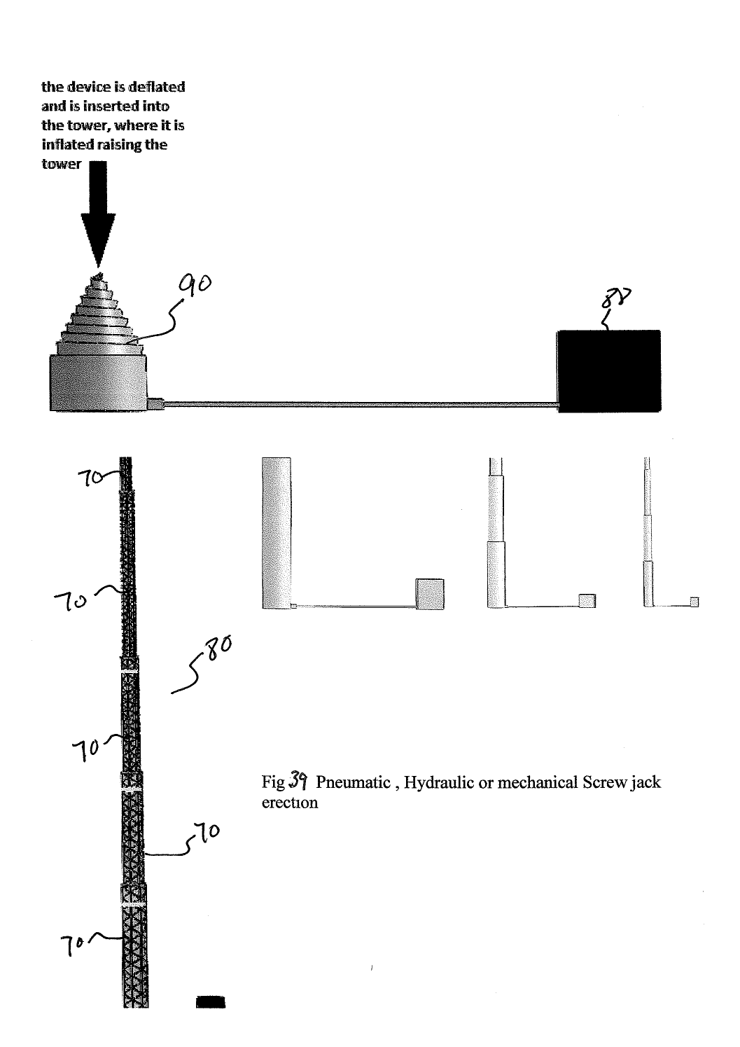

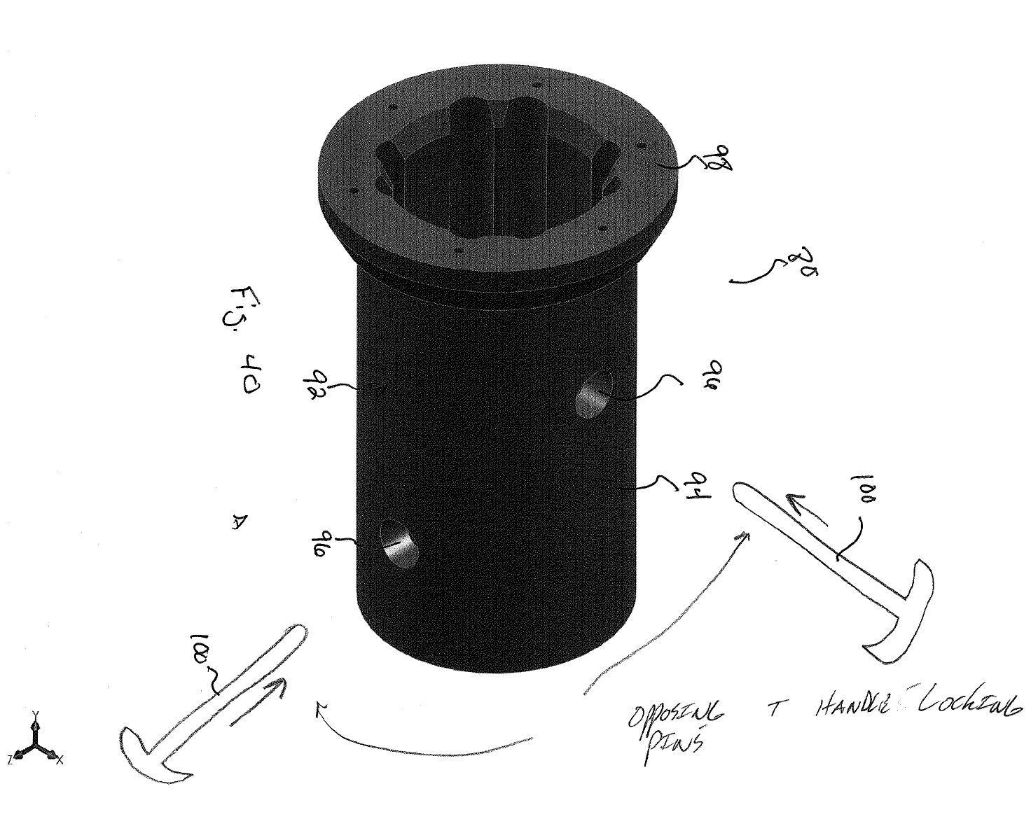

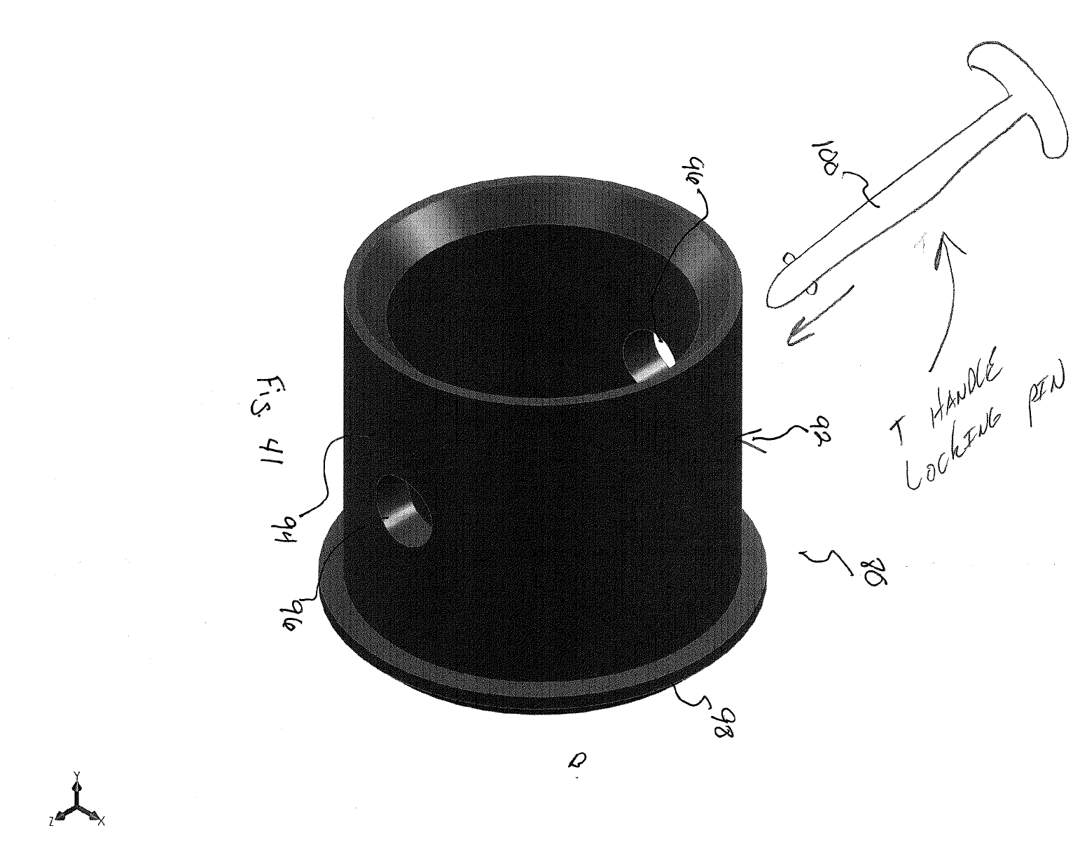

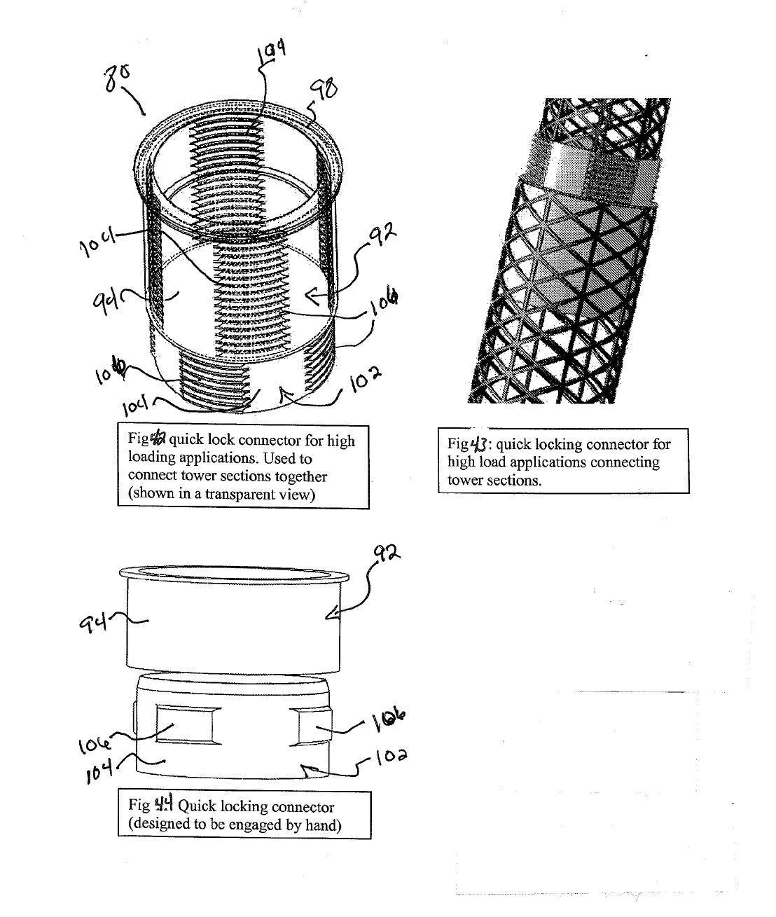

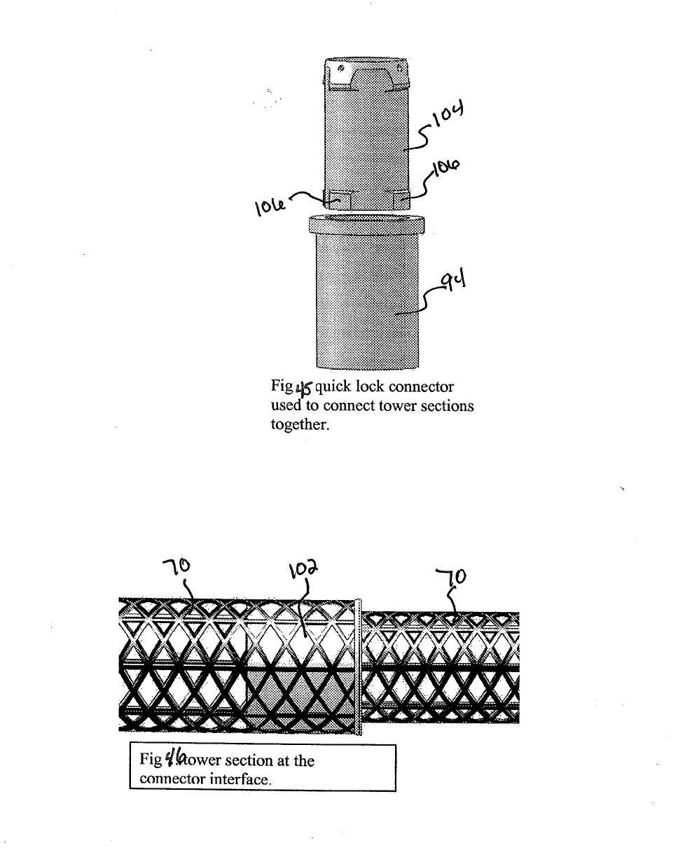

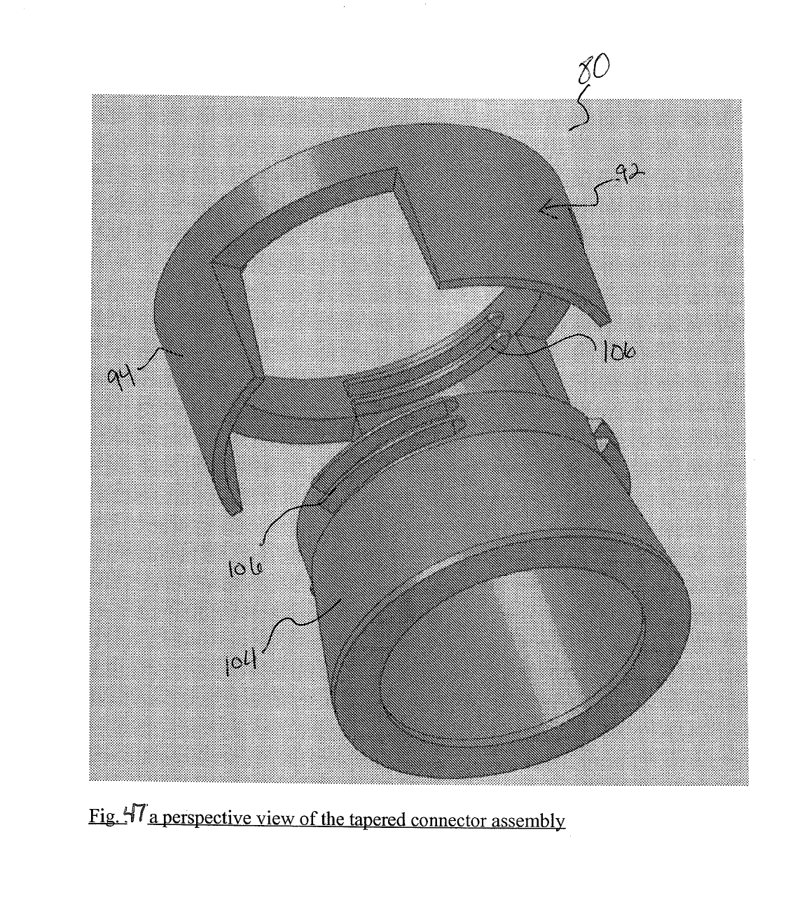

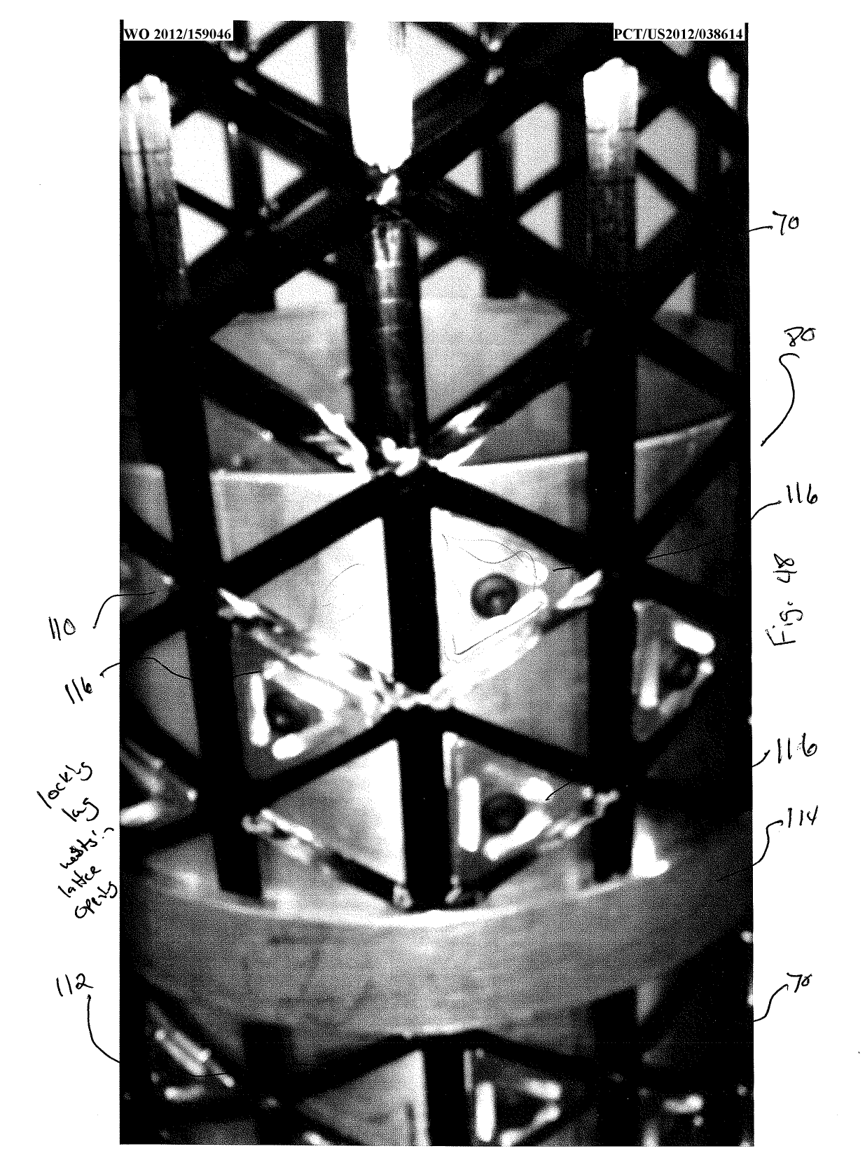

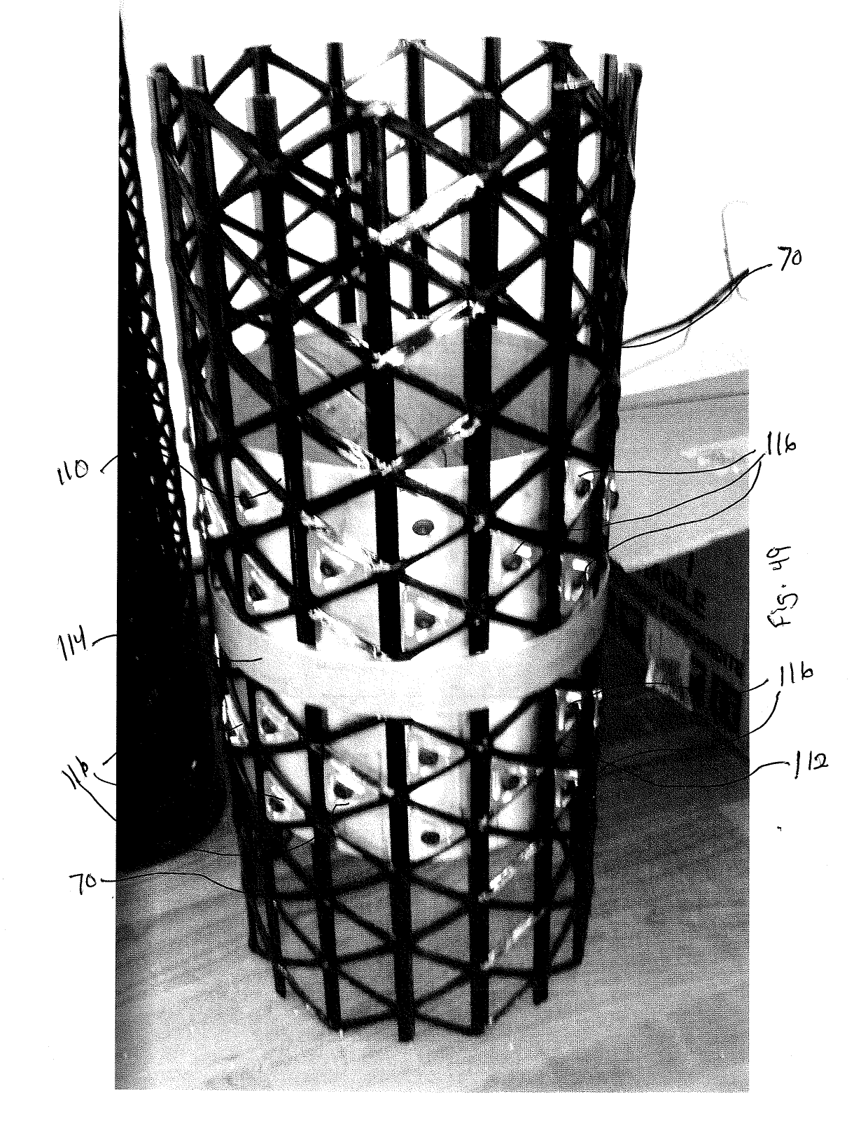

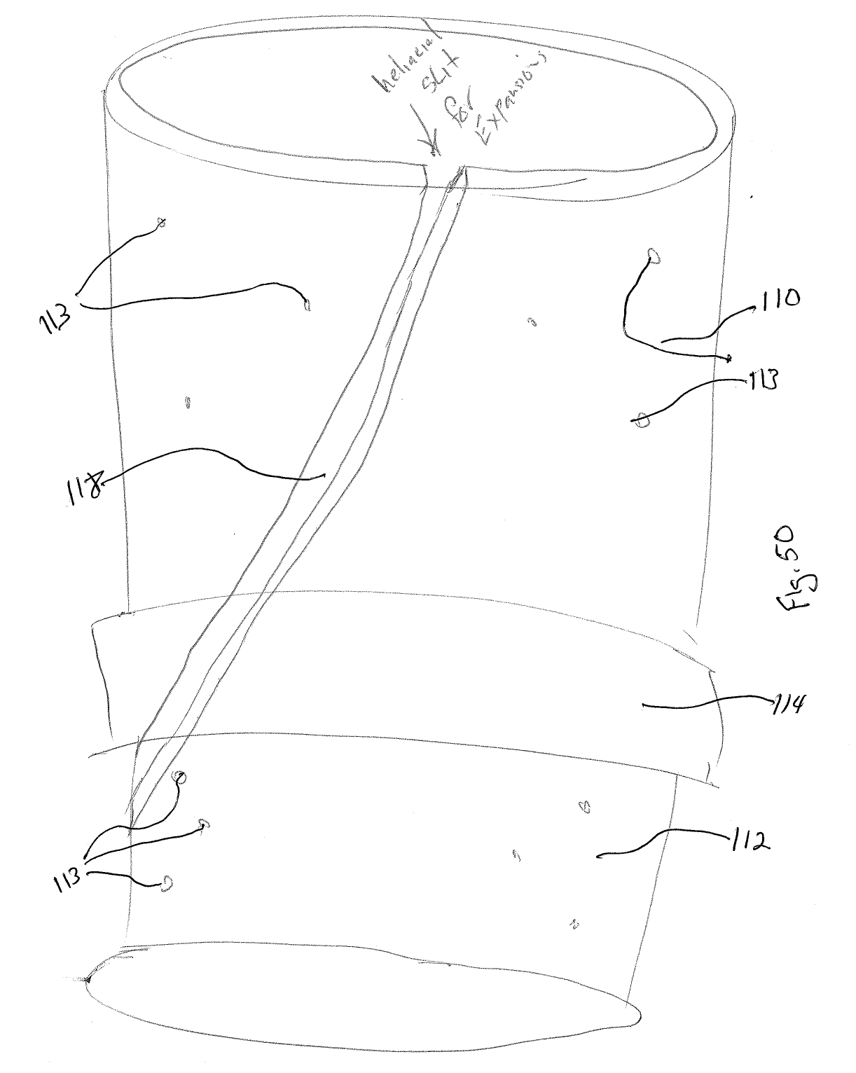

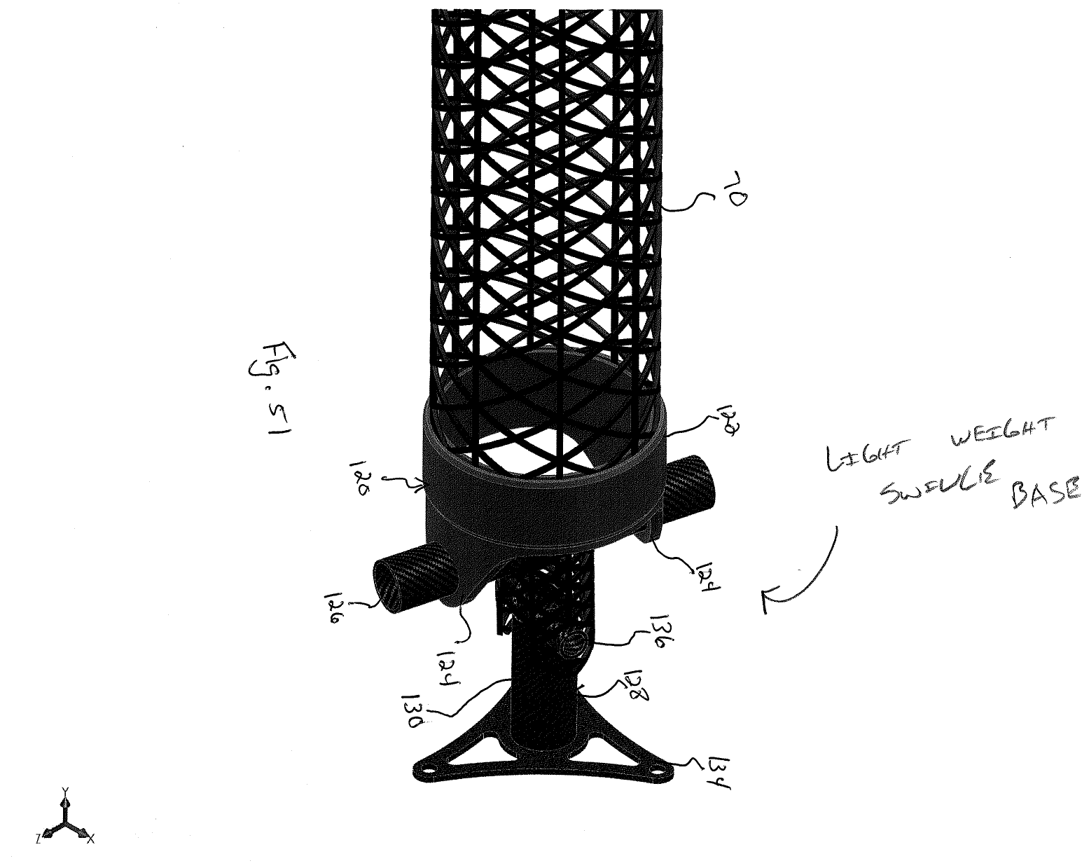

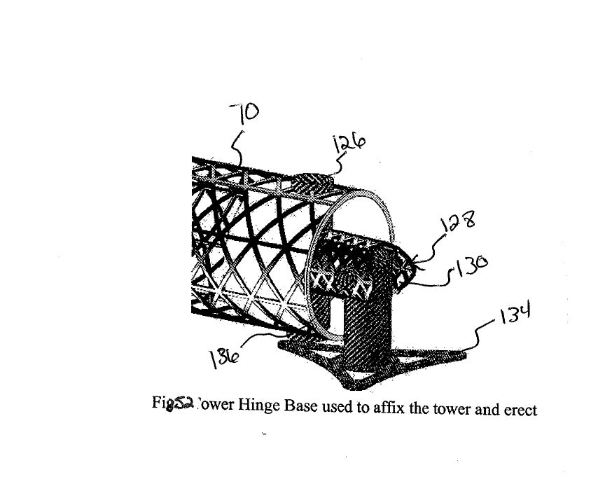

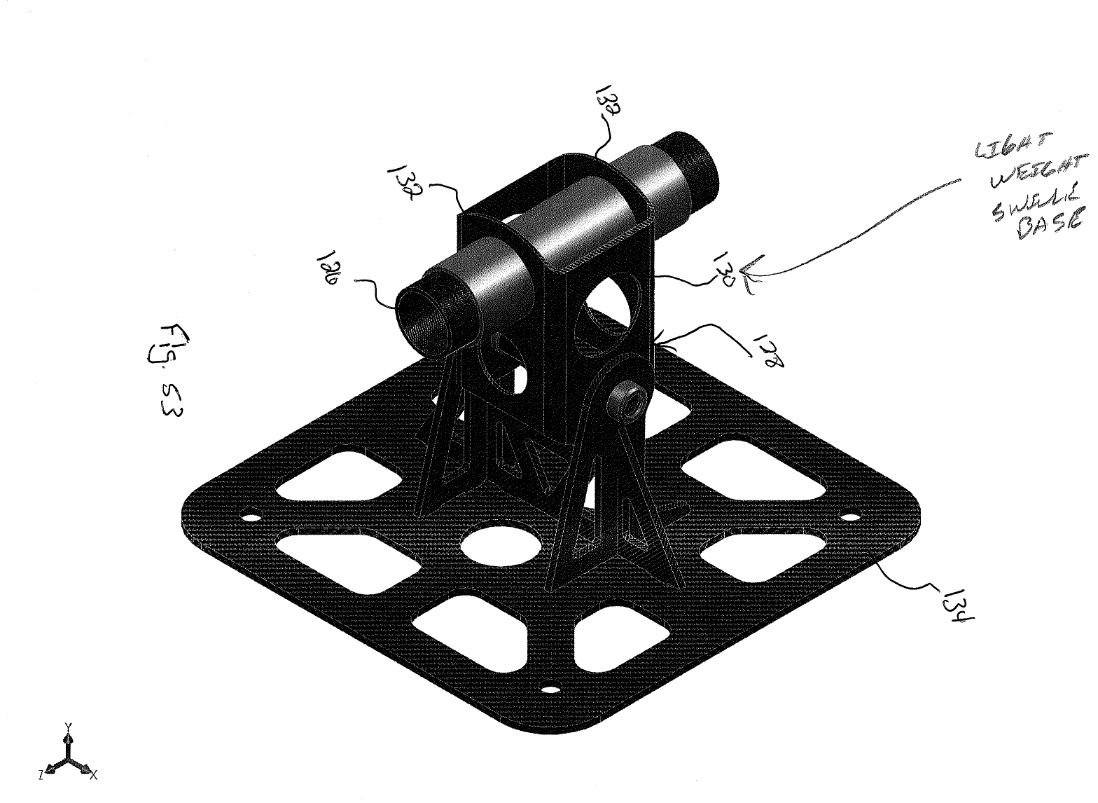

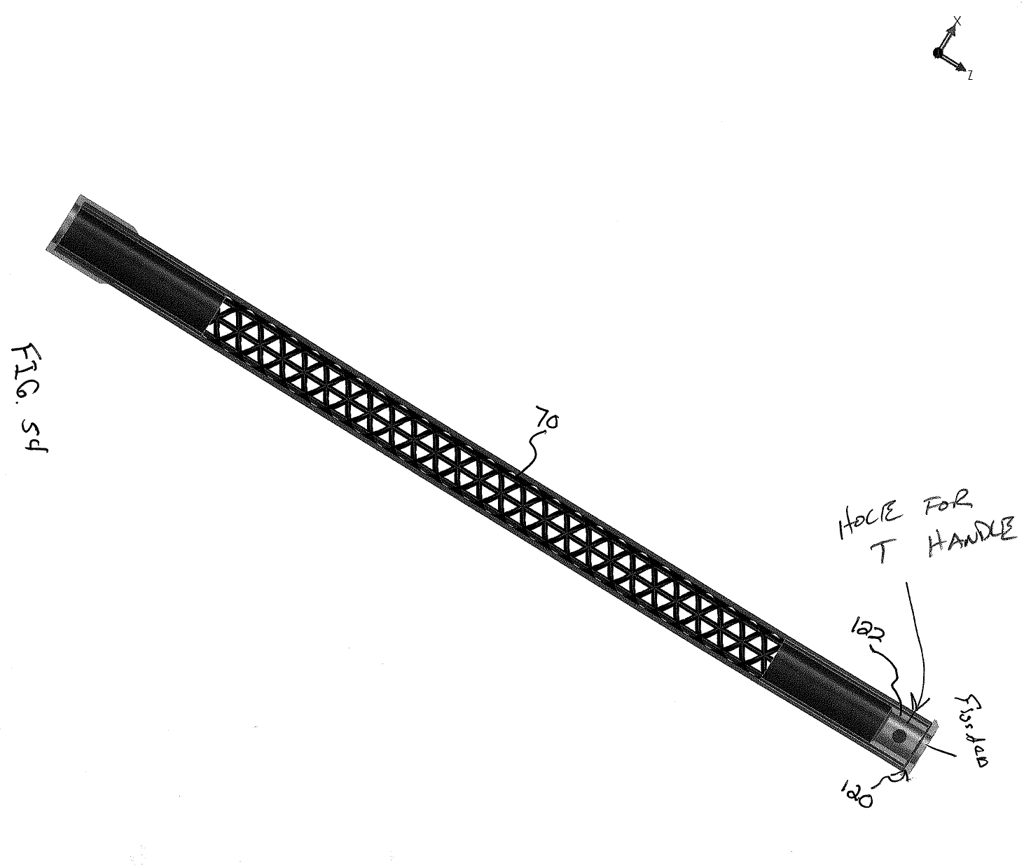

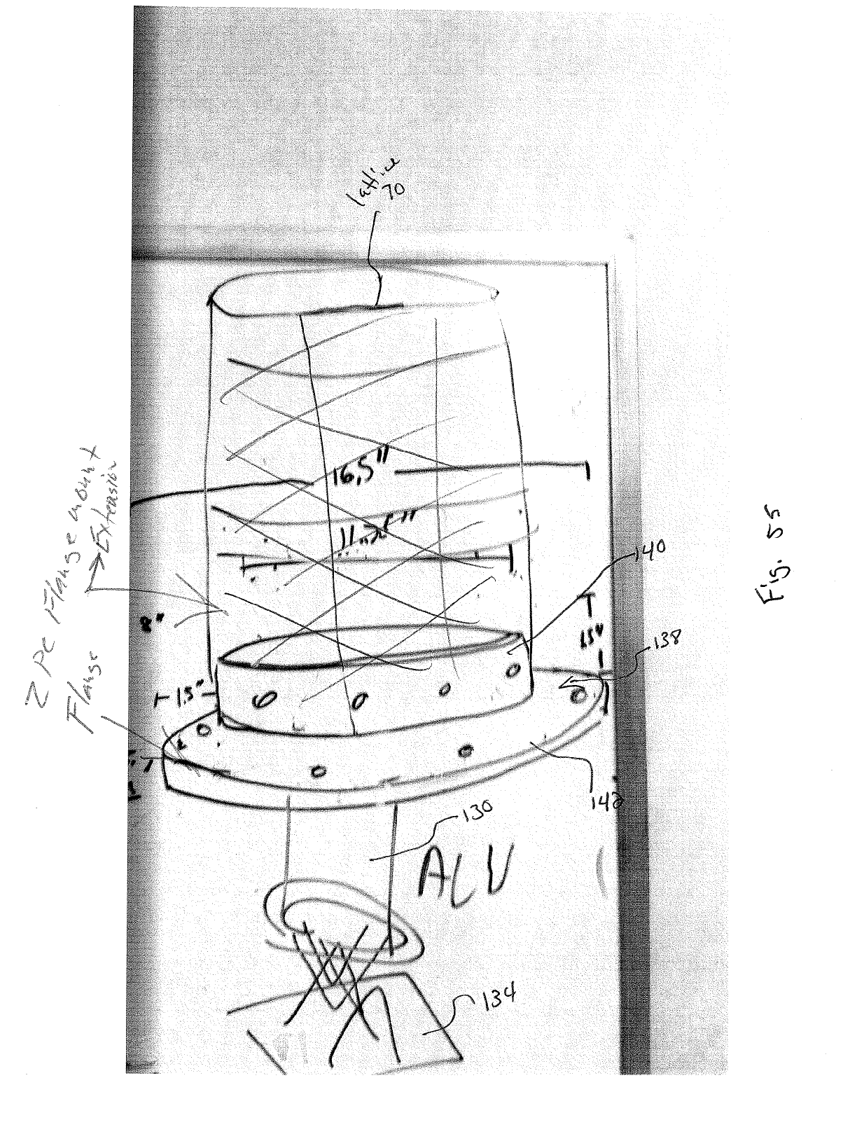

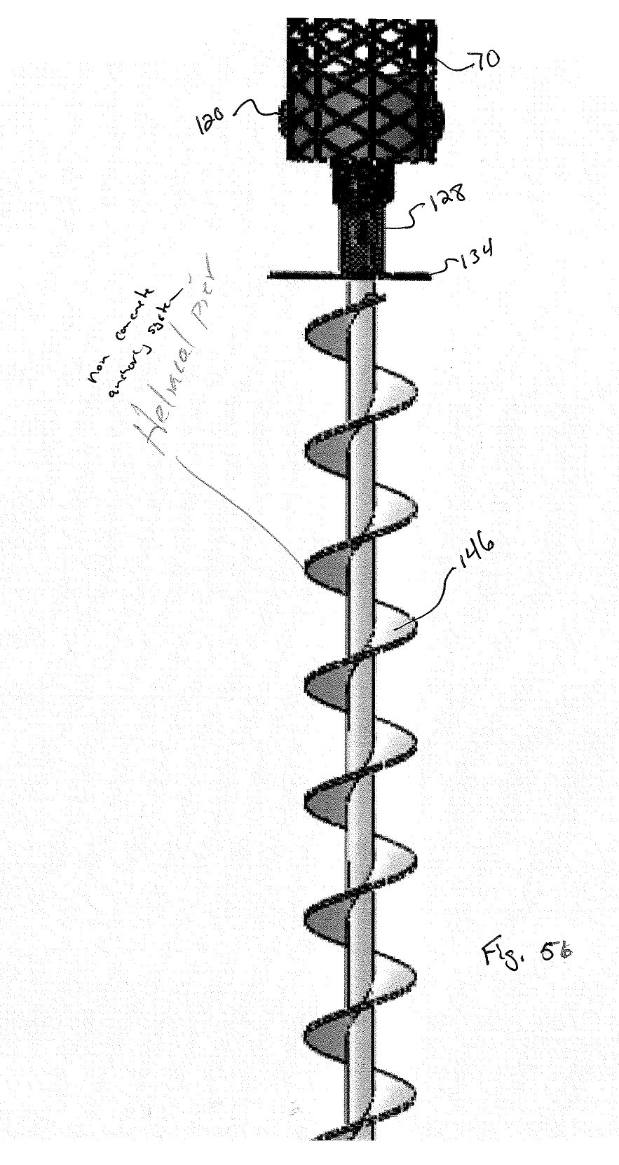

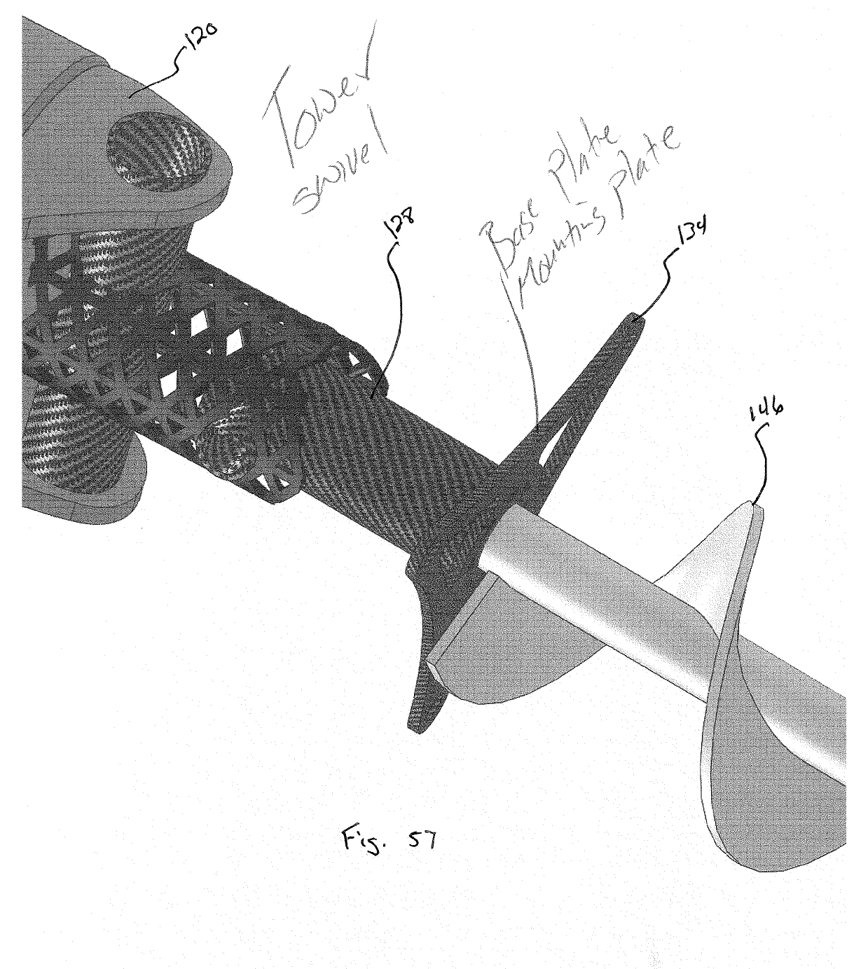

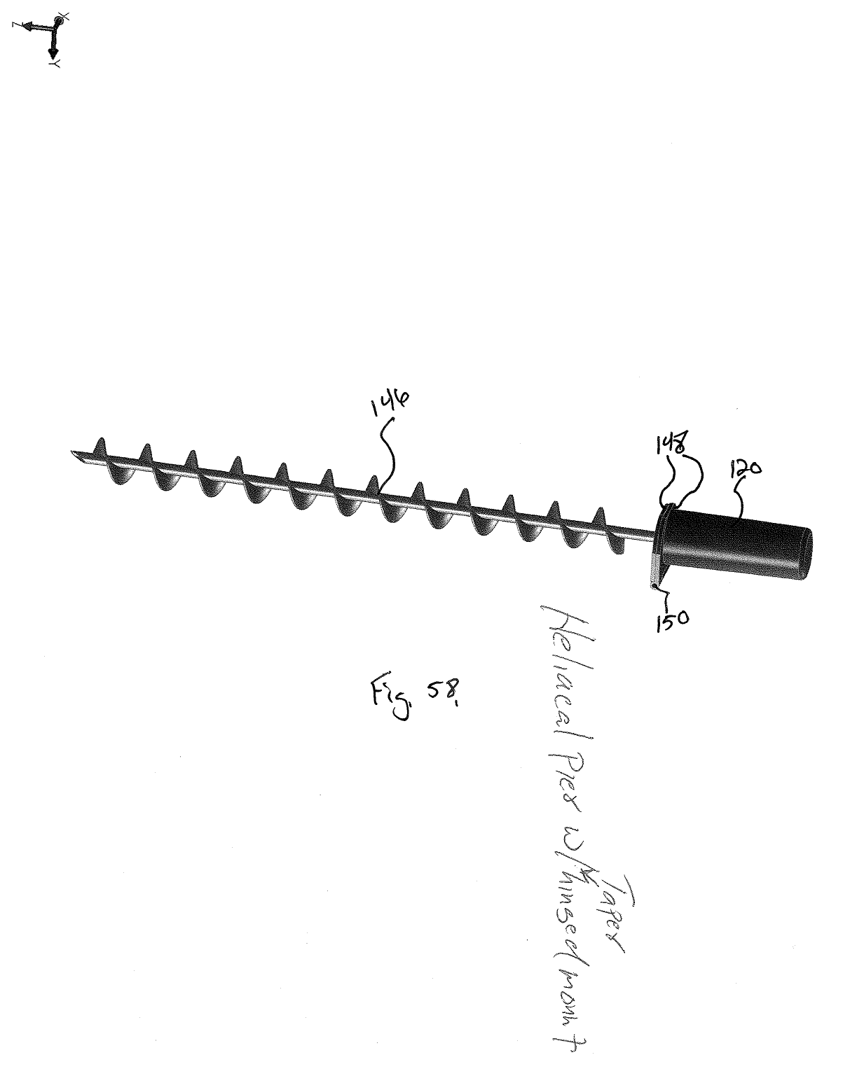

With specific reference to FIGS. 2A and 2B, a rectangular embodiment of a two-dimensional lattice support structure is shown. FIGS. 2A and 2B are identical in external design shape, that of a rectangle enclosed with primary boundary members, 21, and secondary boundary members, 22. In the disclosure of the present invention, the addition and configuration of members between the primary boundary members must include one or more lateral members, 12, to separate the primary border members, 21. FIG. 5A demonstrates this minimal requirement as an independent unit where the unit contains two primary border members, 21, two secondary border members, 22, and multiple lateral members, 12. Additional longitudinal member or members, 11, is a design option based on the application needs of the part. These are placed between the primary border members as shown in FIGS. 2A and 2B. These optional longitudinal members, 11, by definition extend lengthwise the same direction as the primary border members. The number and location of lateral members in a given unit are chosen by the designer based on the types of nodes needed in the application. One exemplary embodiment given in FIG. 2A, primary isogrid nodes, 14, are desired based on the design given in FIG. 1B. The structure is further strengthened by the secondary isogrid nodes, 15, as described in FIG. 1C. With one longitudinal, 11, and various lateral members, 12, overlapped by cross members, 13, running in both directions diagonally. In another exemplary embodiment given in FIG. 2B, secondary isogrid nodes, 16, are sufficient based on the design given in FIG. 1A. The structure is further strengthened by the tertiary isogrid nodes, 16, as described in FIG. 1C. With one longitudinal, 11, and various lateral members, 12, overlapped by cross members, 13, running in both directions diagonally.

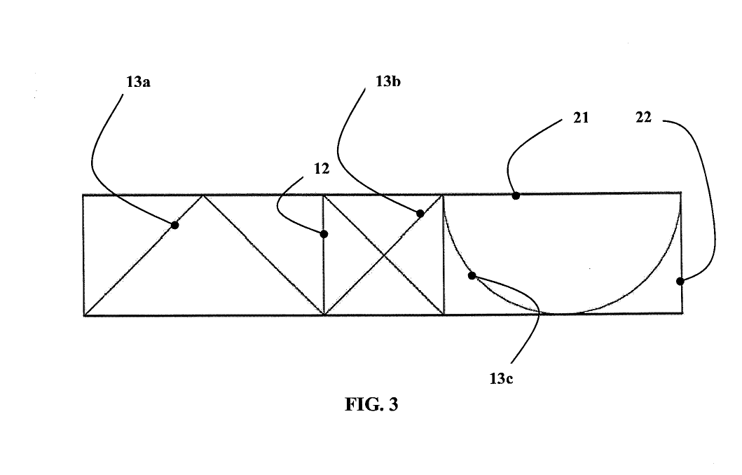

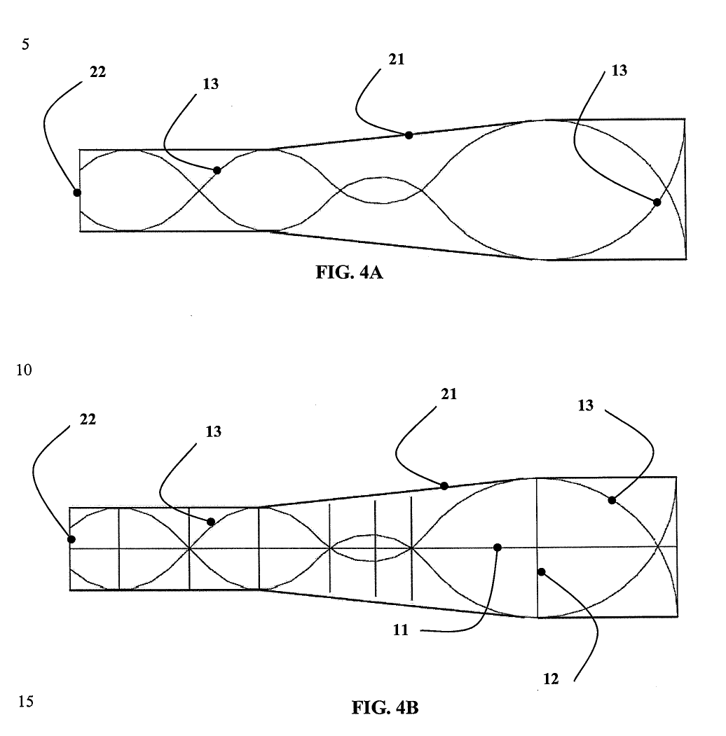

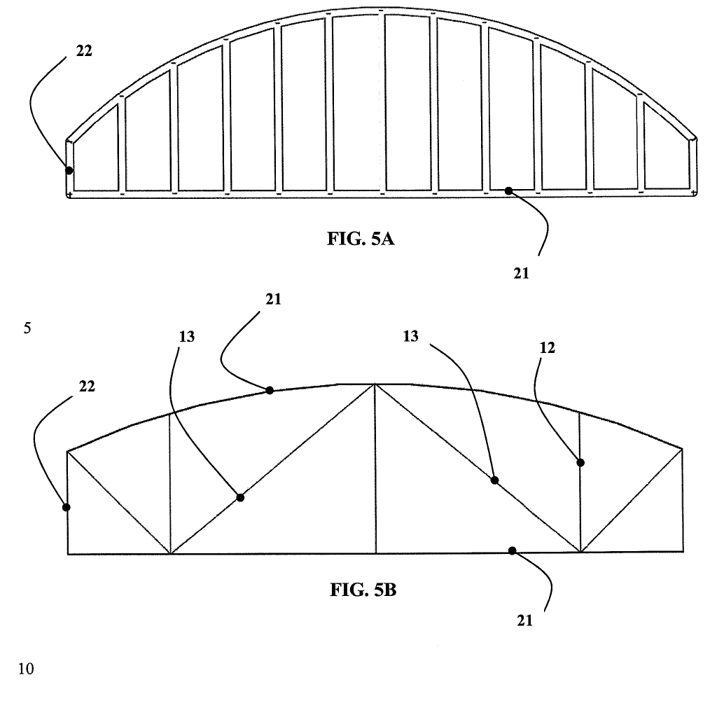

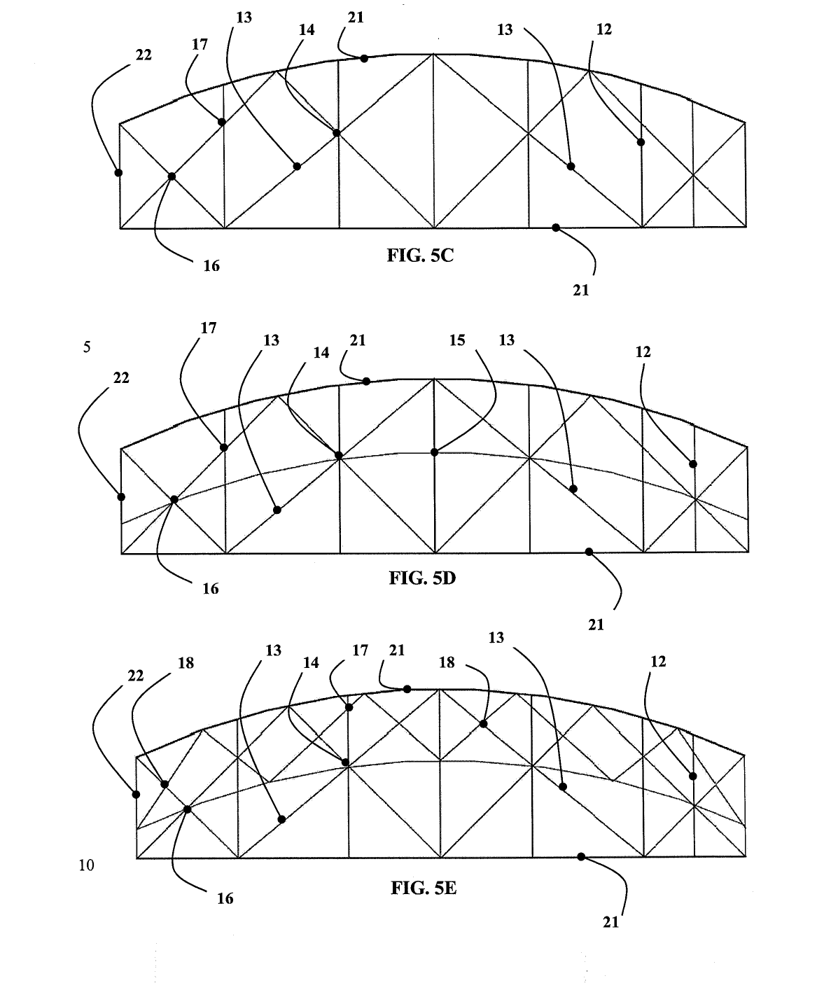

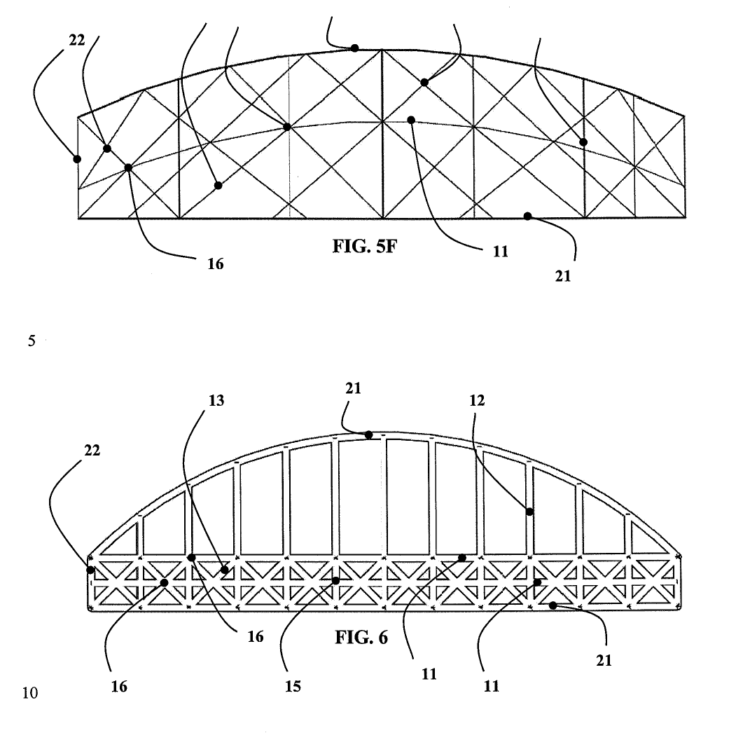

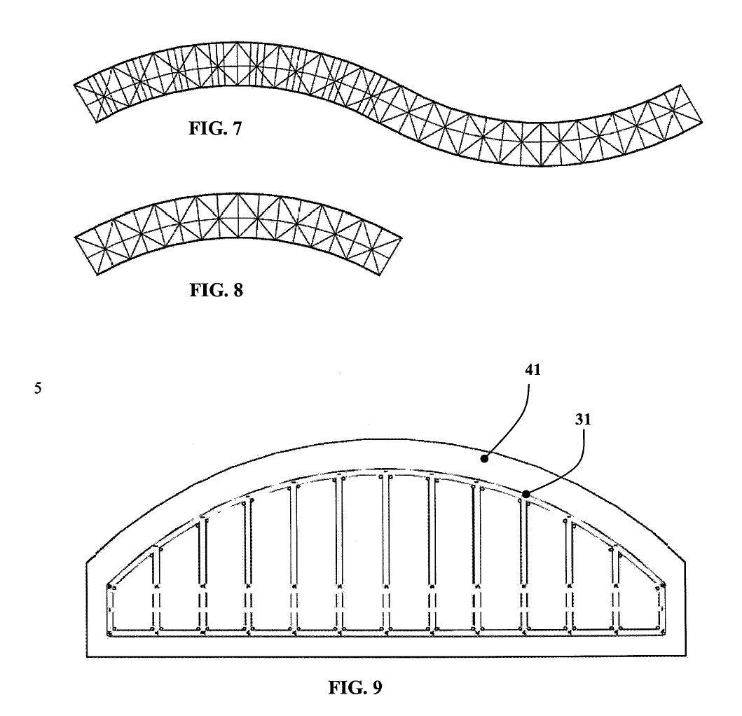

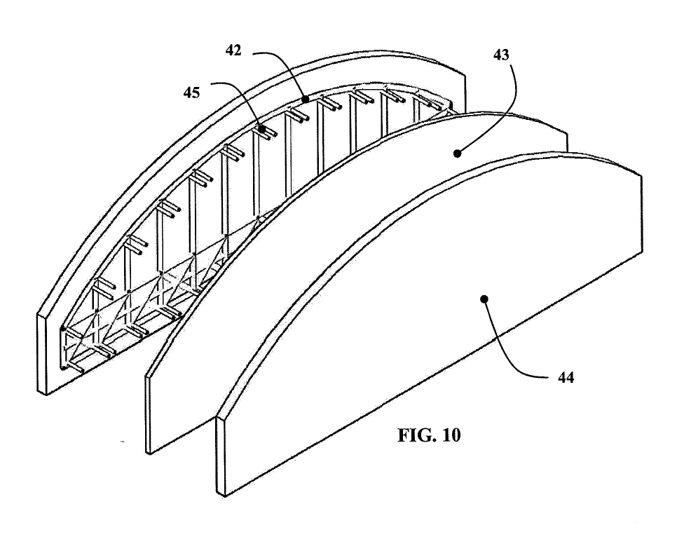

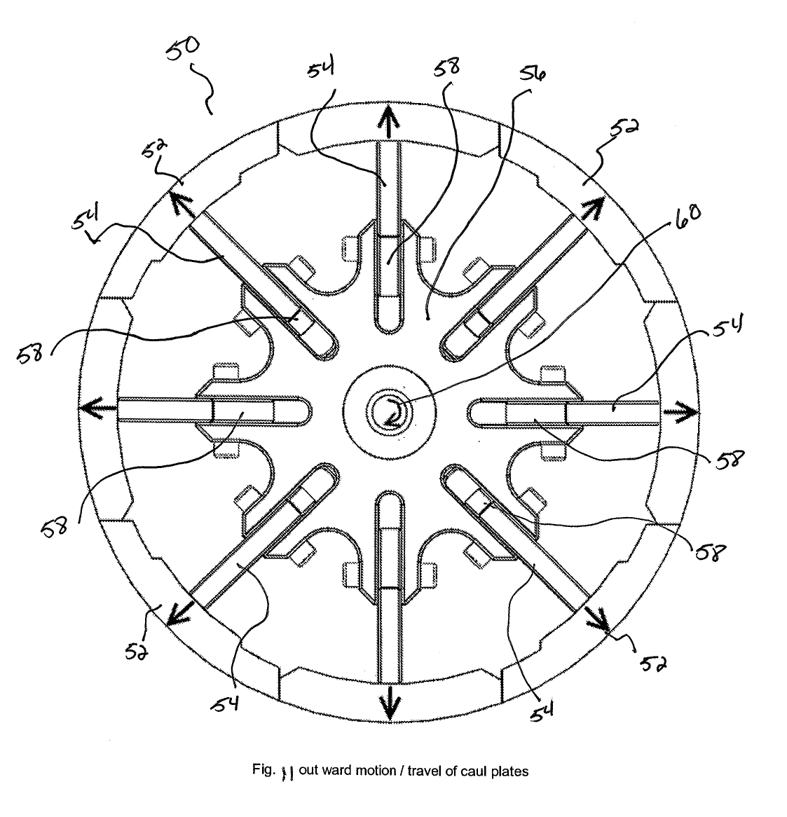

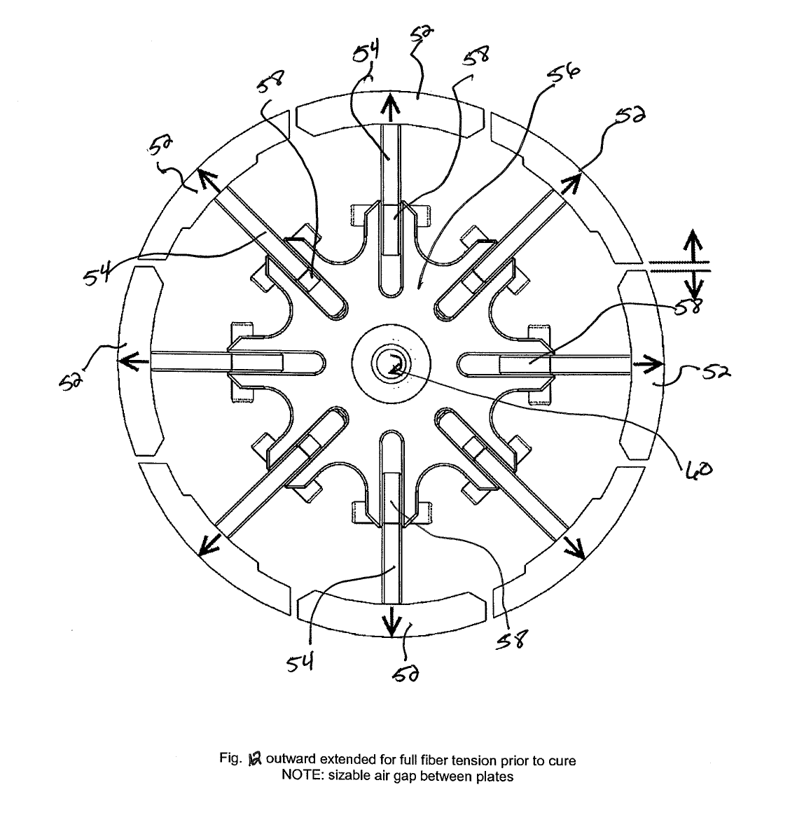

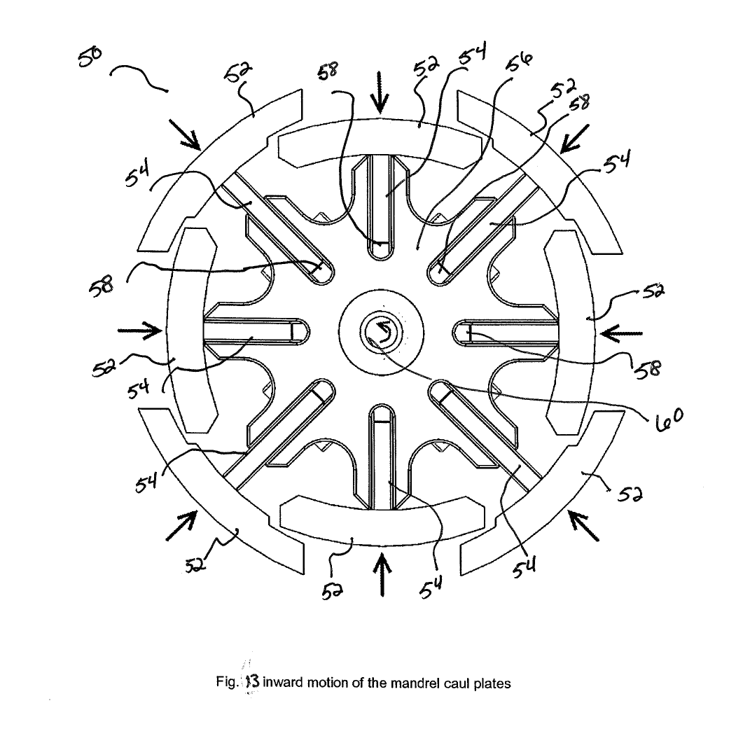

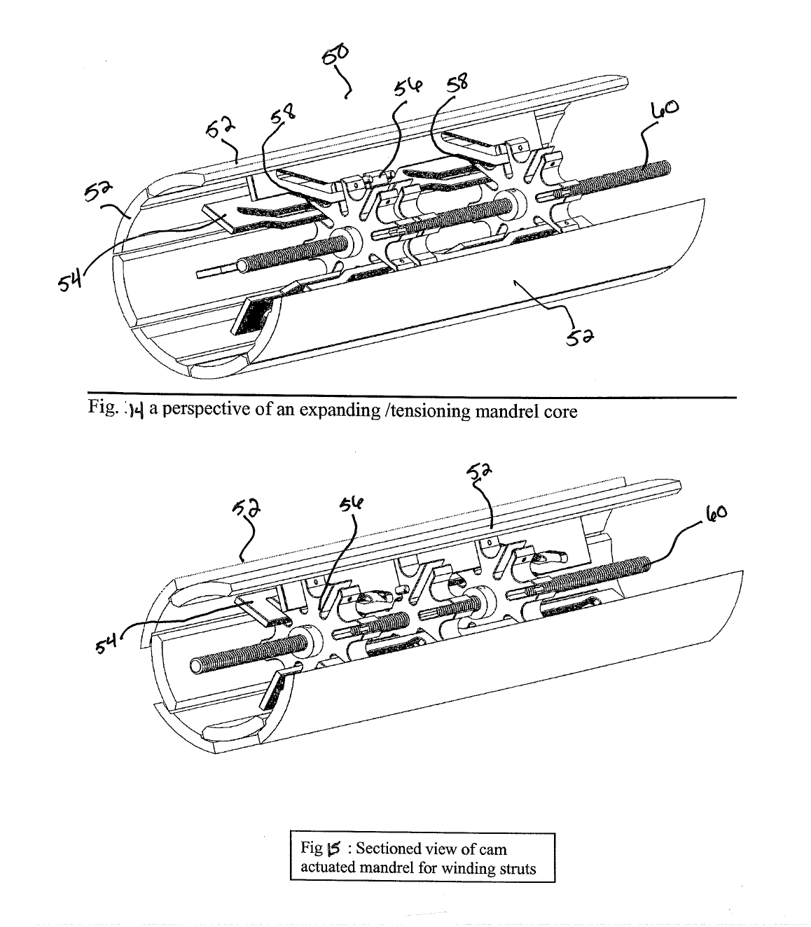

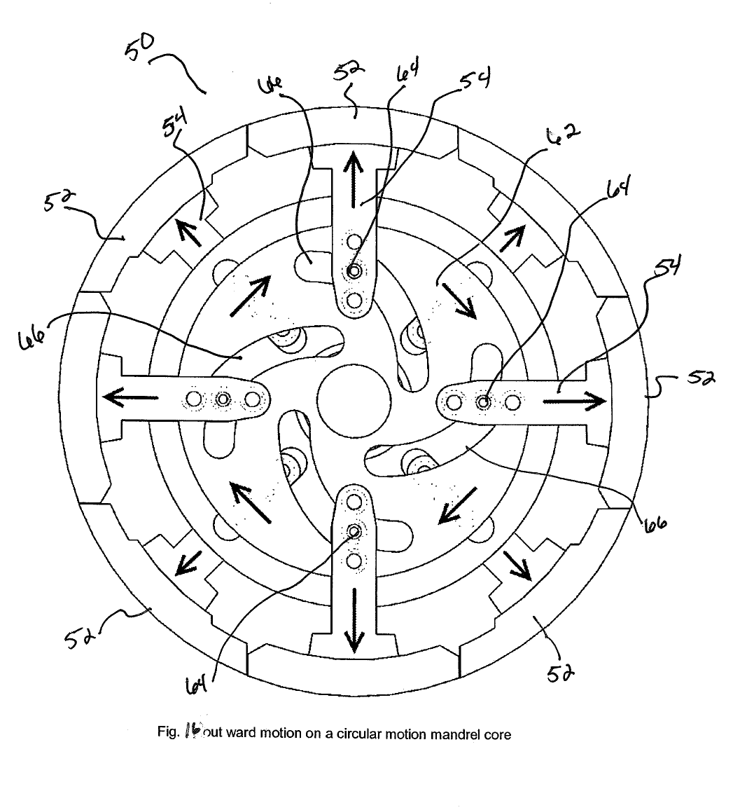

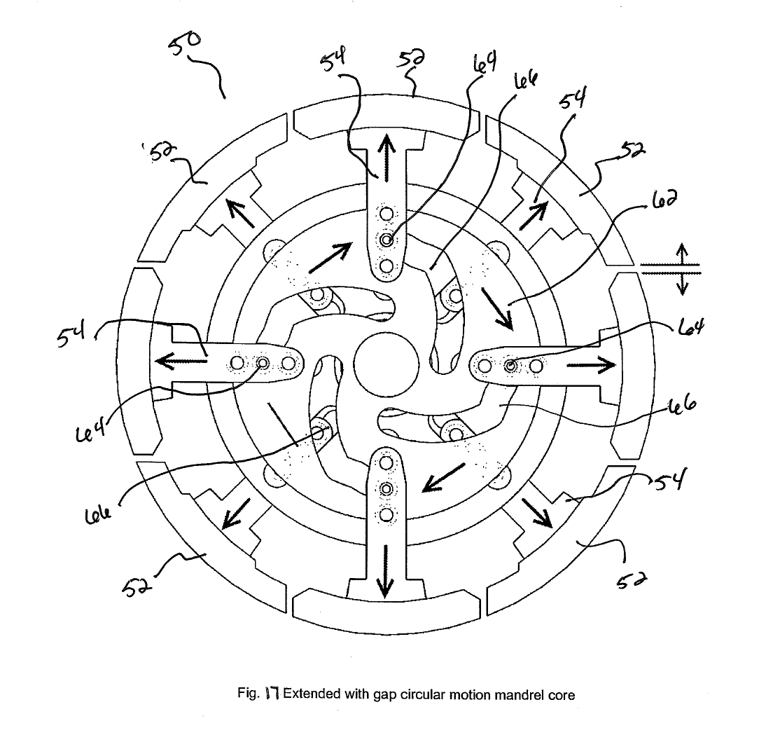

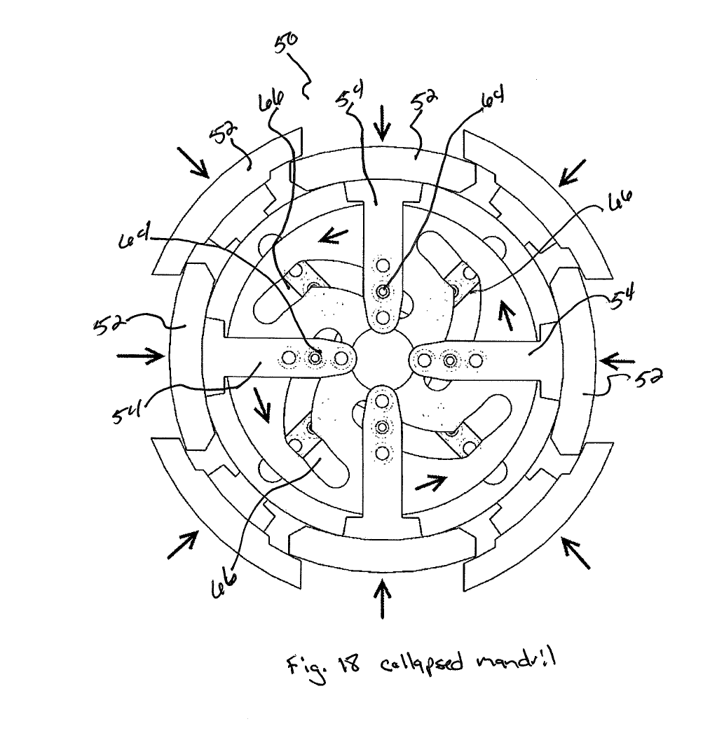

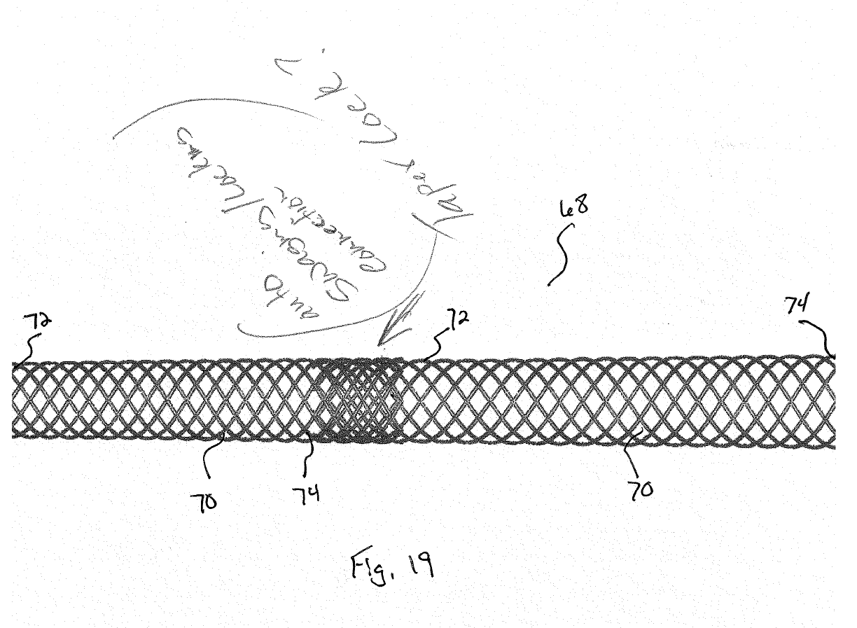

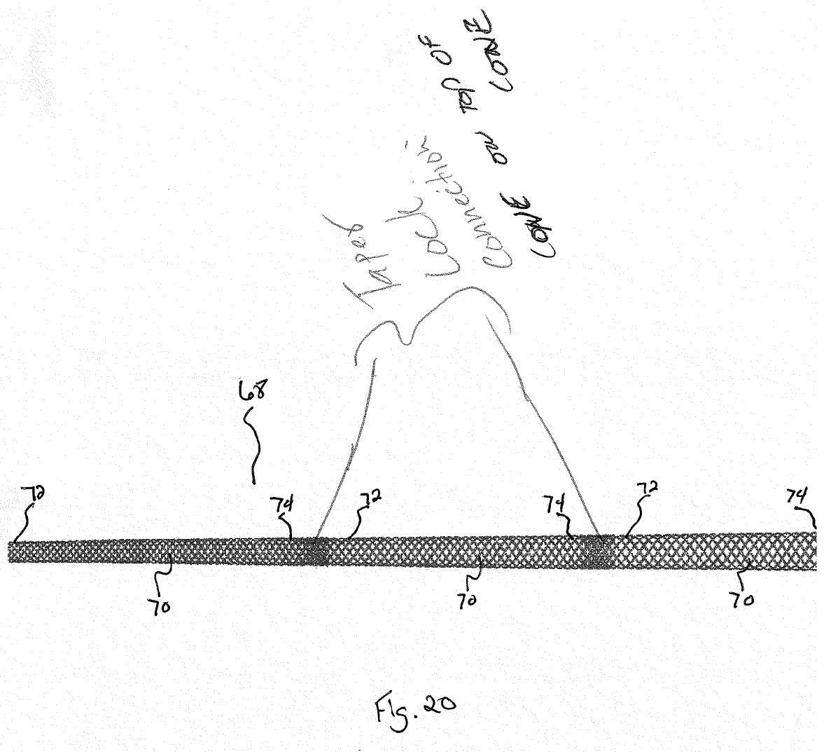

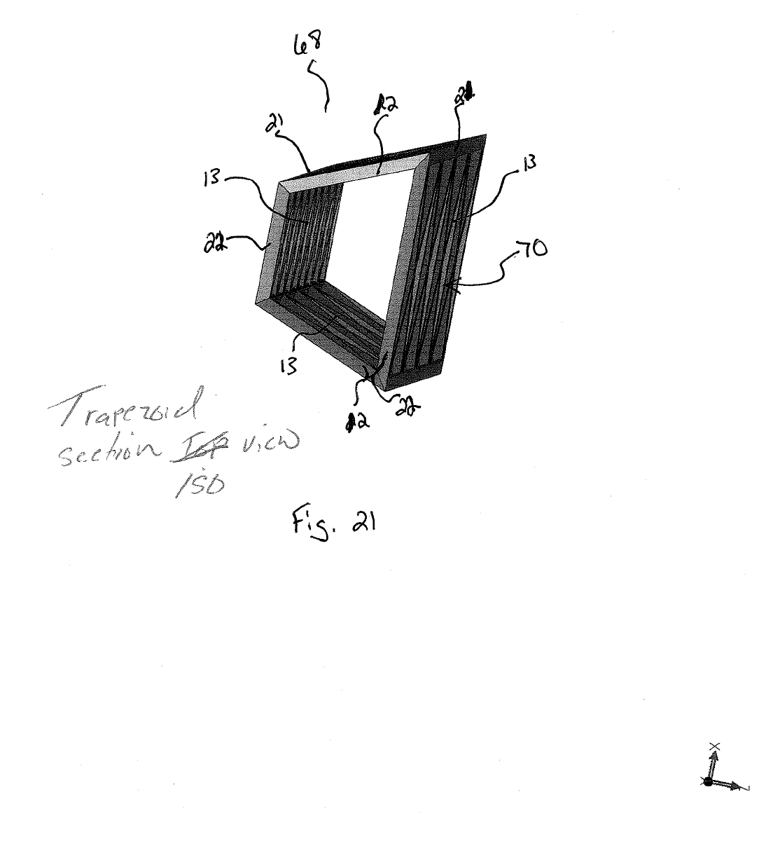

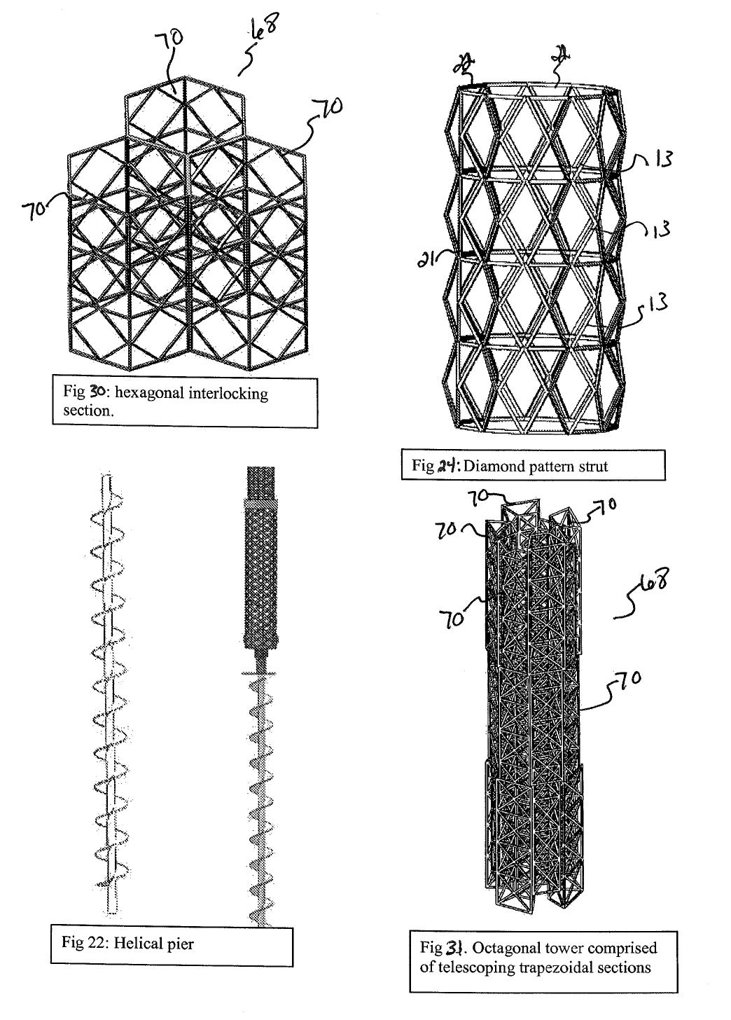

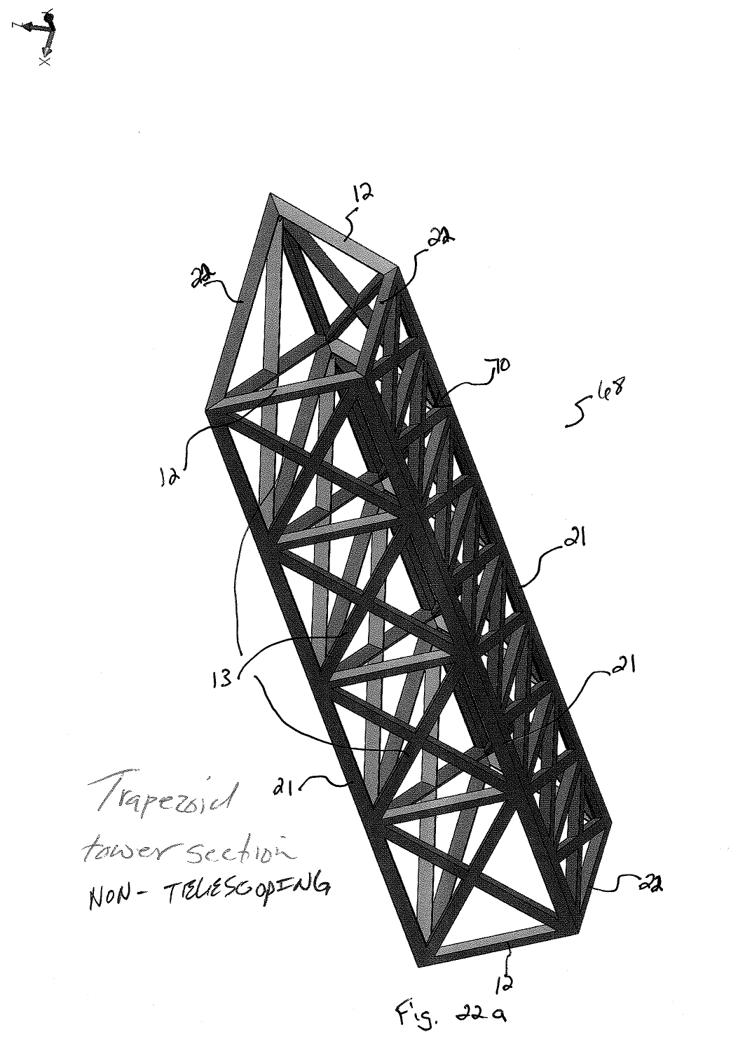

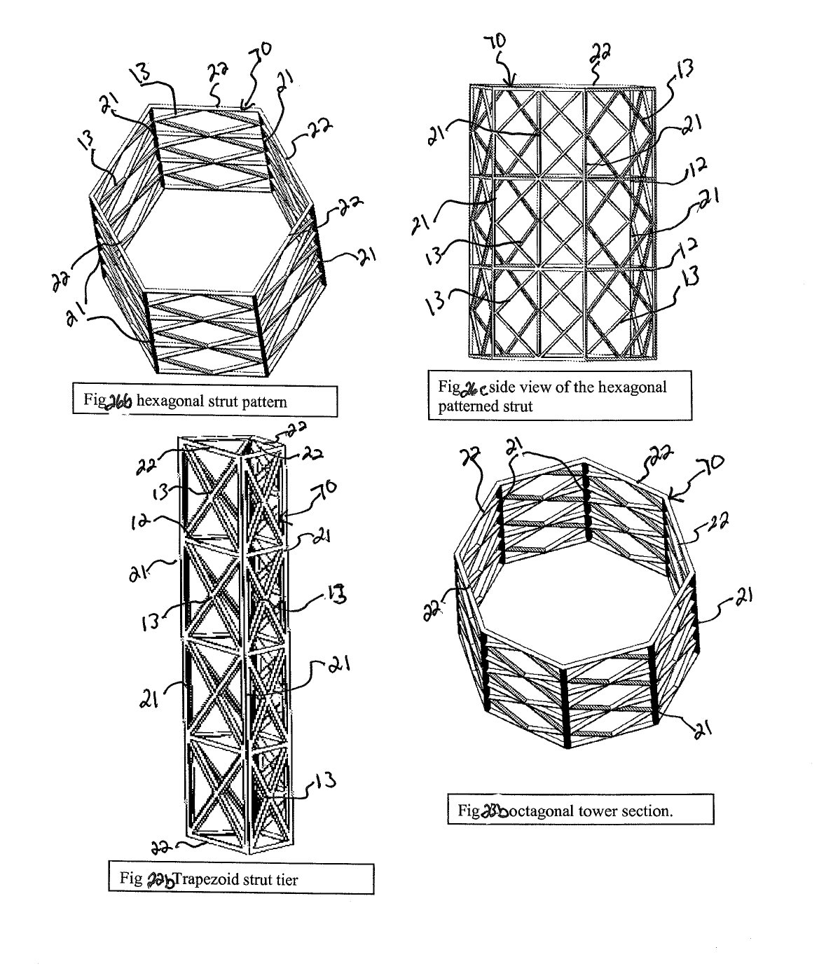

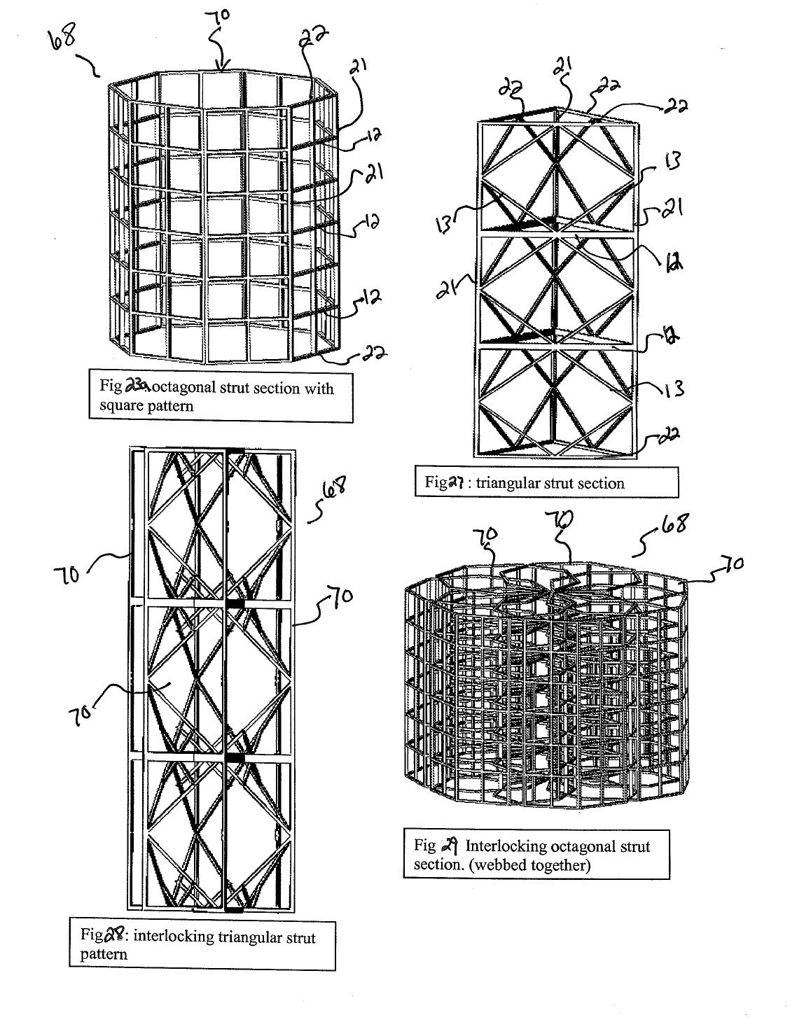

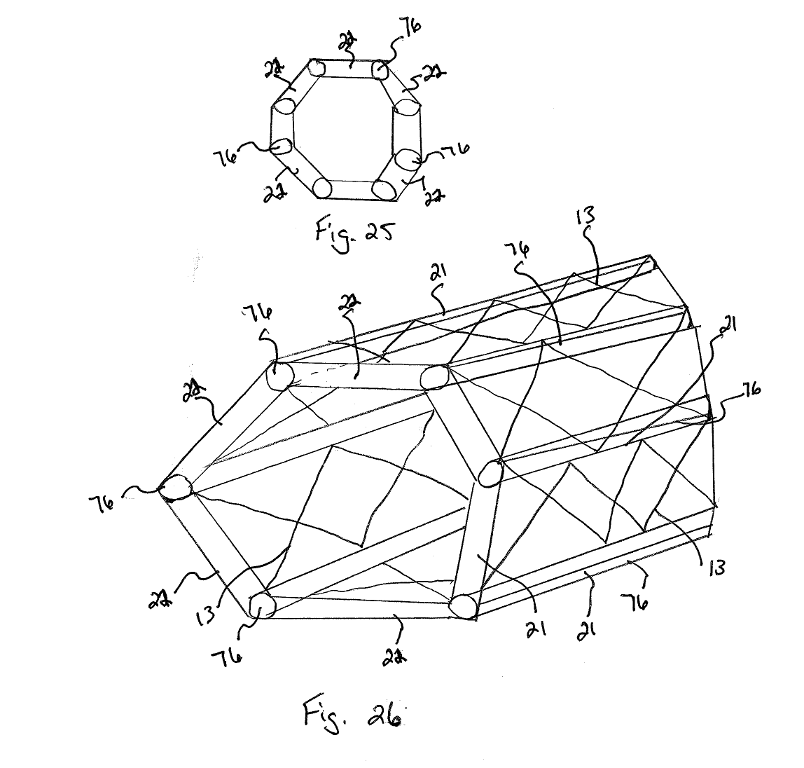

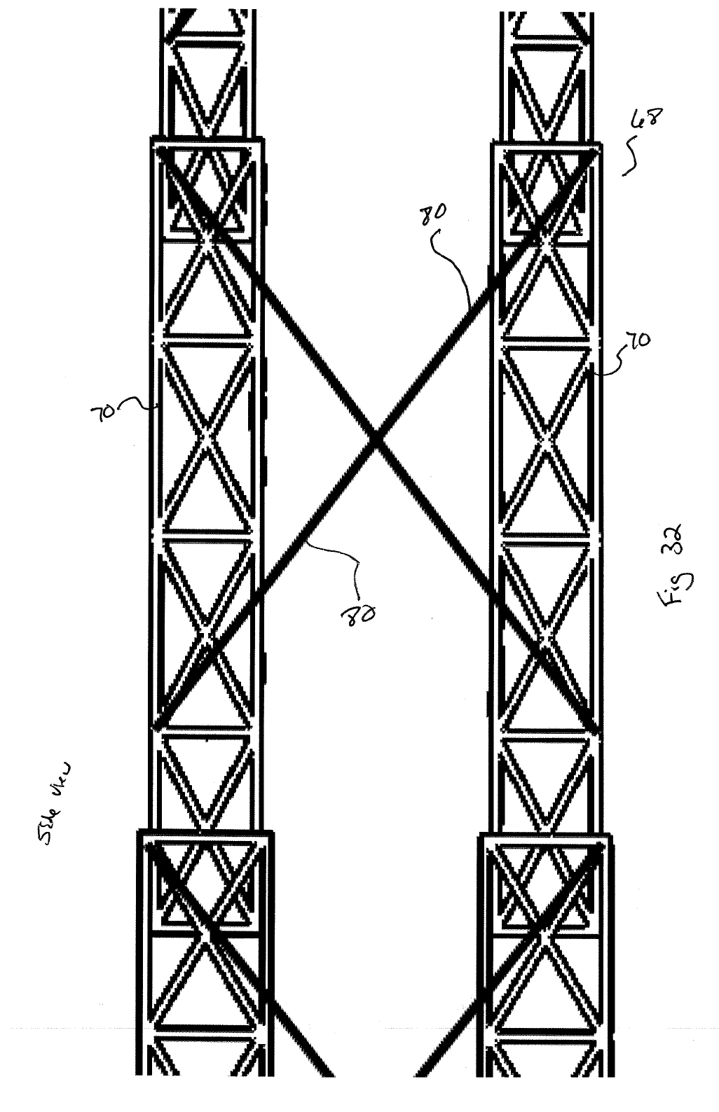

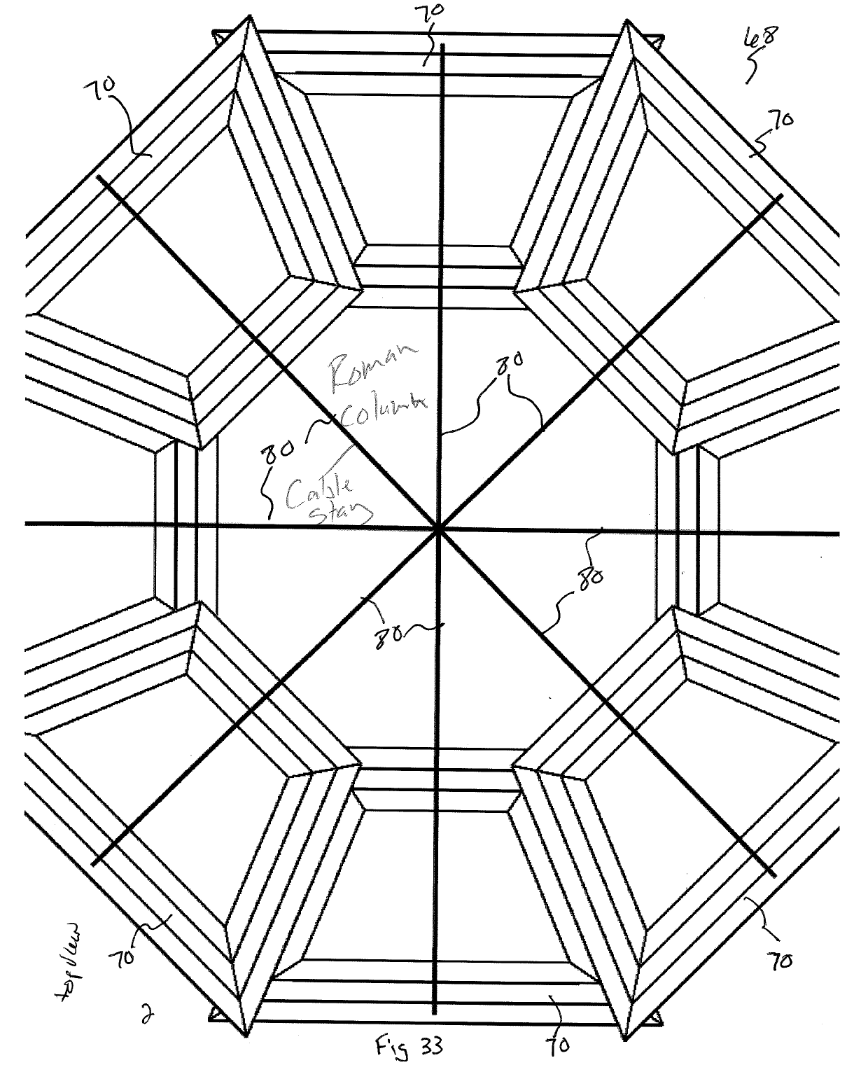

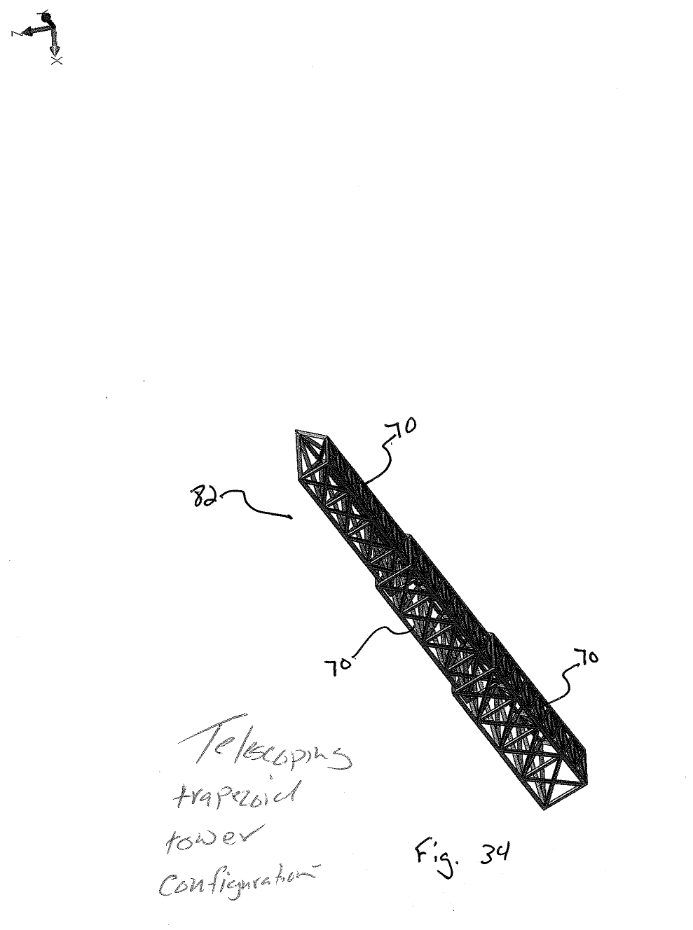

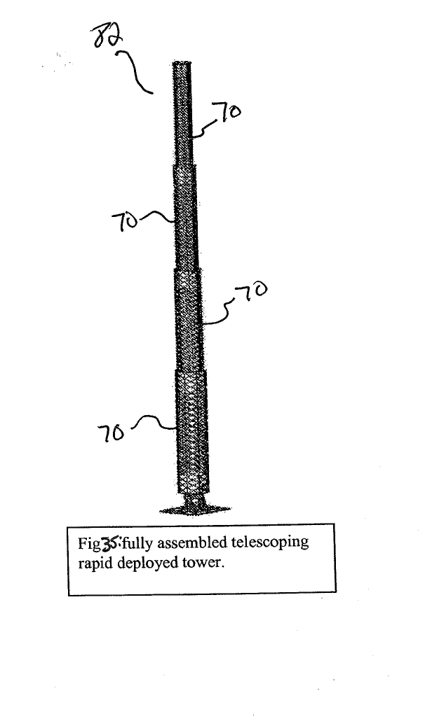

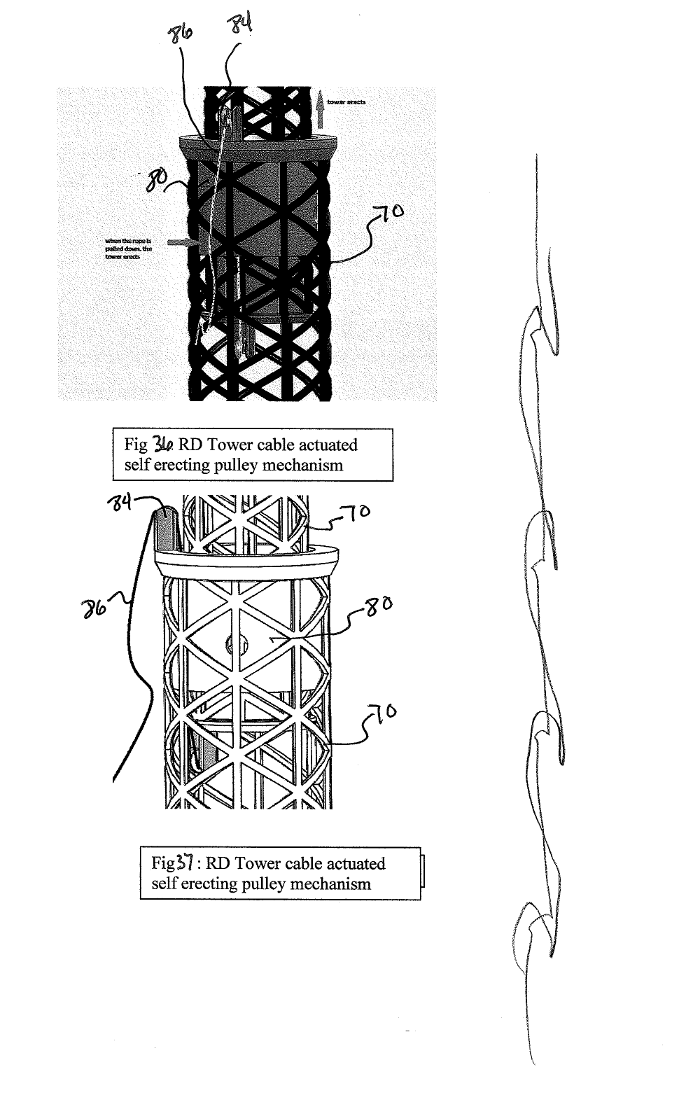

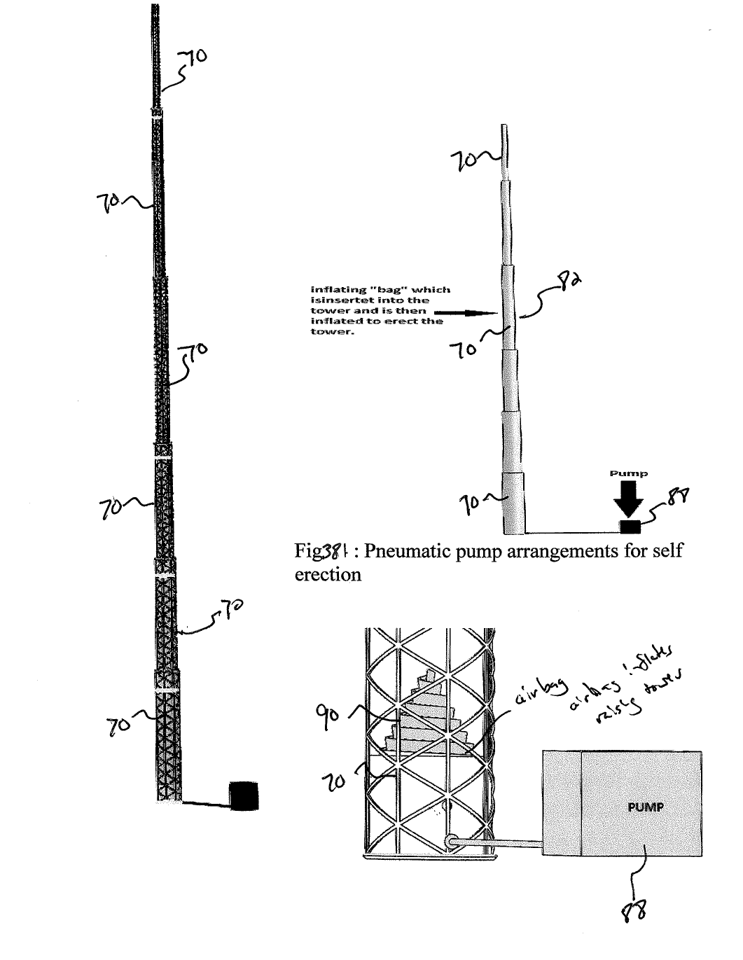

With specific reference to FIG. 3, the members between the primary border members, 21, can take different angles for instance the cross member 13a compared to 13b. These members, whether cross members, laterals, 12, or longitudinals, 11, may also take curvilinear form such as 13c based on the needs of the particular application.

With specific reference to FIGS. 4A and 4B two more embodiments of the two-dimensional lattice structure are shown. In this scenario, the primary border members, 21, are shown to diverge from each other using symmetrical curvilinear form in a single Cartesian plane. In FIG. 4A, the secondary border members, 22, provide the needed bridge between the primary border members and take the place of the necessary lateral(s). The space between the primary border members, 21, is filled with curvilinear cross members, 13. FIG. 4B is identical to FIG. 4A and adds a series of lateral members, 12, to stiffen the structure.

With specific reference to FIG. 5A-5F, more embodiments of the two-dimensional lattice structure are shown where the primary border members differ in shape. In FIGS. 5A-5F, one primary border member is curvilinear while the other remains linear. FIG. 5A demonstrates the minimal member requirement as an independent unit where the unit contains two primary border members, 21, two secondary border members, 22, and multiple lateral members, 12. FIG. 5B takes the basic shape of 5A and demonstrates the addition of cross members, 13, without any intersecting nodes between the primary border members, 21. FIG. 5C takes the shape of 5B and demonstrates the addition of enough cross members, 13, and lateral members, 12, to create primary isogrid nodes, 14, tertiary isogrid nodes, 16, and primary anisogrid nodes, 17 between the primary border members, 21. FIG. 5D takes the shape of 5C and demonstrates the addition of a longitudinal member, 11, to create secondary isogrid nodes, 15. FIG. 5E takes the shape of 5D and demonstrates the addition of cross members, 13, between primary border member, 21, and a longitudinal member, 11, to create a stronger lattice web in half of the structure. FIG. 5F takes the shape of 5E and demonstrates the addition of cross members, 13, between primary border member, 21, and a longitudinal member, 11, to create a stronger overall lattice web balanced throughout the structure between the primary border members.

It is noted that FIGS. 2A to FIG. 8 are provided for exemplary purposes only, as many other structures can also be formed in accordance with embodiments of the present disclosure and still be confined to a single Cartesian plane. For example, cross member angle can be modified for cross supports, longitudinal cross supports added symmetrically or asymmetrically, lateral cross supports can be added uniformly or asymmetrically, node locations and/or number of cross supports can be varied as can the overall geometry of the resulting part including height, width, length and the body-axis path to include constant, linear and non-linear resulting shapes as well as the radial path to create circular, triangular, square and other polyhedral cross-sectional shapes with or without standard rounding and filleting of the corners, etc. contained within a single Cartesian plane. In other words, these lattice supports structures are very modifiable, and can be tailored to a specific need. For example, if the weight of a lattice support structure needs to be reduced, then cross lattice support structures can be removed at locations that will not experience as great of a load. Likewise, cross lattice support structures can be added where load is expected to be greater.

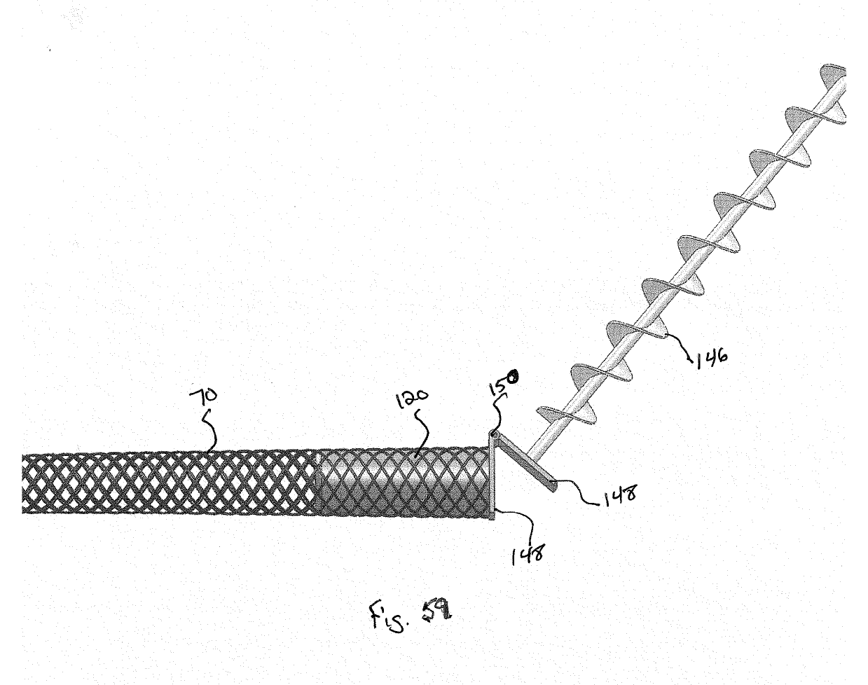

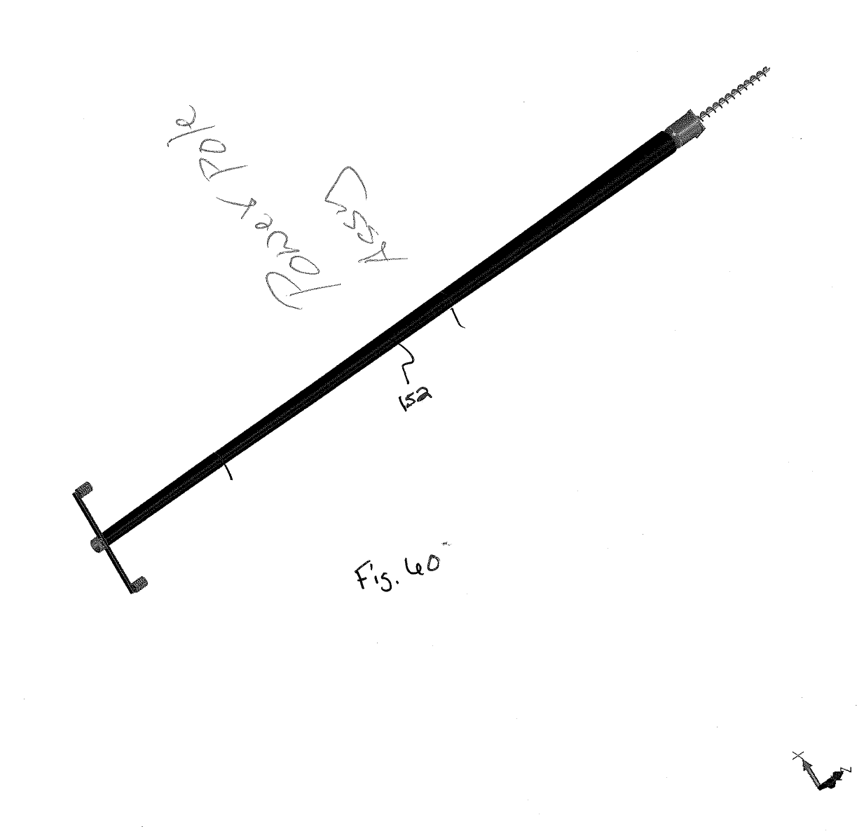

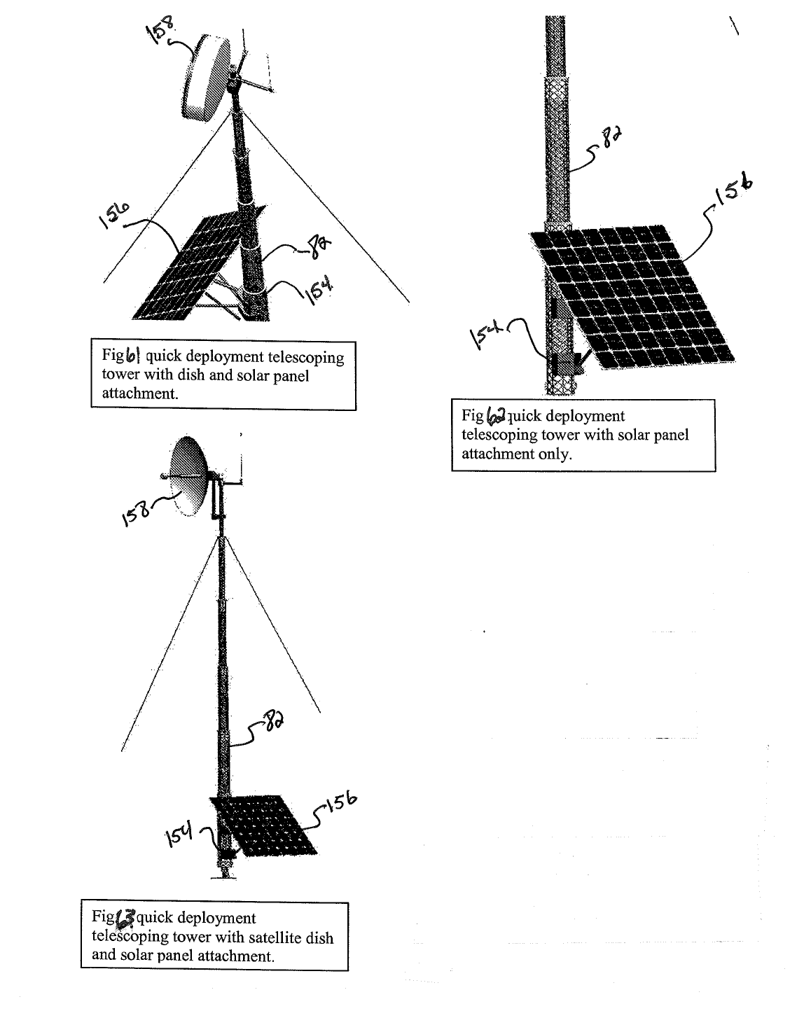

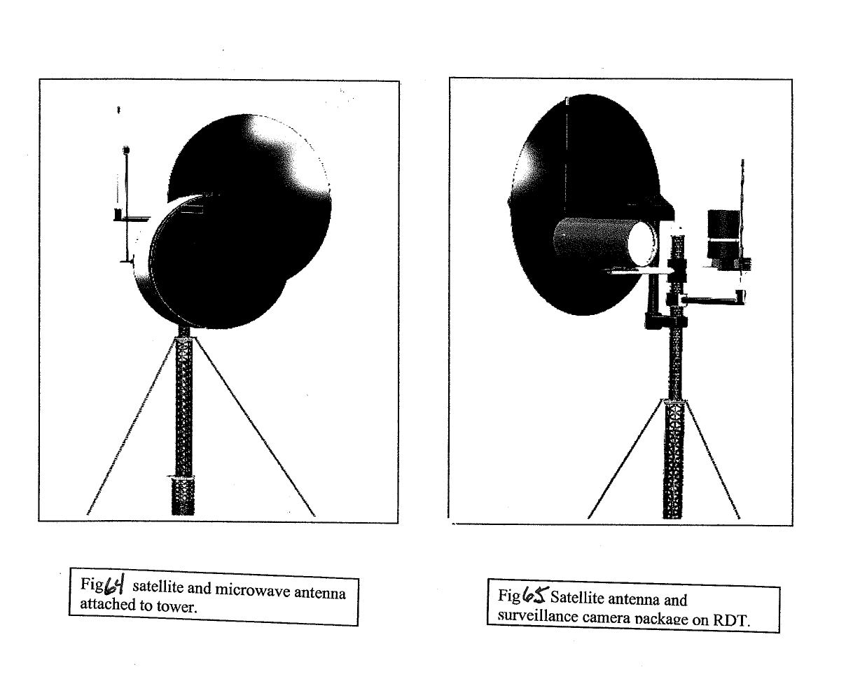

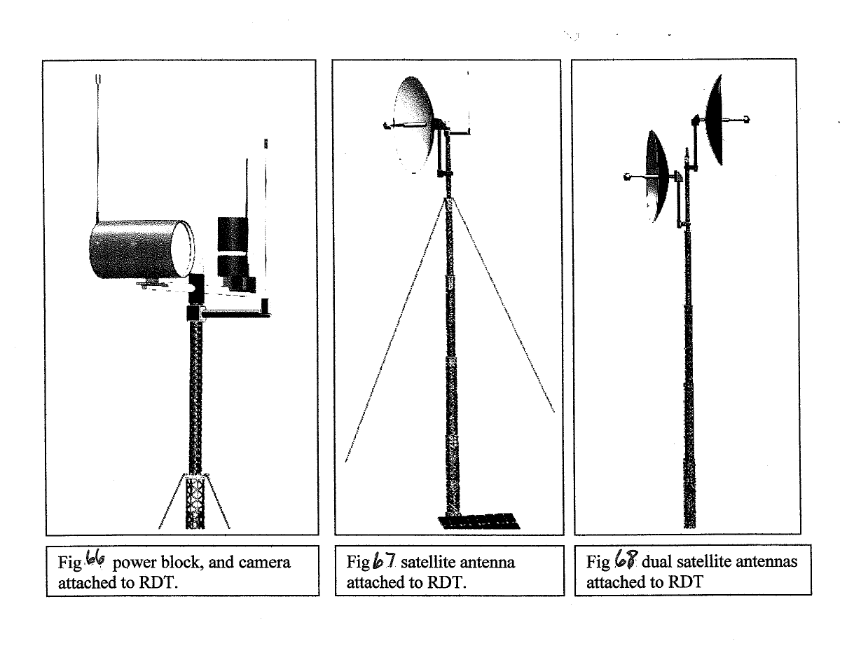

In accordance with this, FIGS. 6-8 provide exemplary relative arrangements for primary and secondary border members as well as lateral, longitudinal and cross members that can be used in forming two-dimensional lattice support structures confined to a single Cartesian plane with linear and curvilinear primary border members.

Structural supports may be covered with a material to create the appearance of a solid two-dimensional structure, protect the member or its contents, or provide for fluid dynamic properties. The current disclosure is therefore not necessarily a traditional board, stud, I-beam, or solid flat bar, neither is it a reinforcement for a skin cover. Even though the structures disclosed herein are relatively lightweight, because of its relative strength to weight ratio, these lattice support structures are strong enough to act as stand-alone structural units. Further, these structures can be built without brackets to join individual lattice support structures.

In accordance with one embodiment, the present disclosure can provide a lattice structure where individual supports structures are wrapped with uni-directional tow, where each cross member, for example, is a continual strand. Further, it is notable that an entire structure can be wrapped with a single strand, though this is not required. Also, the lattice support structures are not weaved or braided, but rather, can be wrapped layer by layer. Thus, where the cross member supports intersect one another and/or one or more longitudinal and/or lateral cross member and/or border members, these intersections create multi-layered isogrid or anisogrid nodes of compounded material as described above in definitions 7-11 which couple the members together. In all embodiments, the composite strand does not protrude from a single Cartesian plane at these multi-layered nodes to form any three-dimensional polyhedral or cylindrical shape when viewed from the axial direction. Thus, the strand maintains their path in its own planar direction based on the geometry of the part. Once wrapped in this manner, the multi-layered nodes and the entire part can be cured and/or fused as described herein or by other methods, and the multi-layered nodes can be consolidated.

It is also noted that these lattice support structures can be formed using a solid mandrel, having grooves embedded therein for receiving filament when forming the lattice supports structure. FIG. 9 shows an exemplary rendition of such a solid mandrel, 41. The grooves, 31, can be contained on the surface as shown or extend completely to the edges of the surface to facilitate ease of wrapping. Being produced on a mandrel allows the cross members of the structural unit to be round, triangular or square or any sectional form of these including but not limited to rounding one or more corners. For production, the filaments are wrapped into the grooves of the mandrel and governed by protrusions, such as pins, at critical corners generally conforming to the desired patterns of the members and providing a solid geometric base for the structure during production. Though a secondary wrap, e.g., KEVLAR®, may be applied once the structure has been cured or combined with the primary fibers before cure, consolidation of members can be achieved through covering the uncured structure with a bagging system, creating negative pressure over at least the multi-layered nodes, and running it through an autoclave or similar curing cycle. This adds strength through allowing segments of components to be formed from a continuous filament, while also allowing the various strands in a single member to be consolidated during curing.

FIG. 10 demonstrates another method of fabrication where the solid grooved mandrel, 41, contains the wrapped part, 42, in its grooves. A Silicone or other flexible sheet, 43, cover the part, while a flat, solid piece, 44, is used to couple with the solid mandrel or a supportive solid piece beneath it, for example with pins or screws, 45, to allow the application of pressure on the part without subjecting it to an autoclave cycle. The unit is then cured in a standard oven cycle, radiation curing process or chemical agent system as dictated by the resin used.

In yet another method of fabrication the open lattice composite matrix support structures are formed using an expandable manufacturing tool or mandrel 50. FIGS. 11-15 depict one embodiment of an expandable tool 50 that may be used to form the lattice structures of the present invention. FIG. 11 depicts an embodiment of the tool 50 in a pre-load configuration, thereby ready to receive a winding of filaments/fibers around the circumference of the tool or mandrel 50. The expandable tool 50 includes a plurality of guide plates 52 that are connected to one or more linear cams 54. The linear cams 54 are secured and guided by one or more cam guides 56 and are operably adjoined to cam bearings 58, which push or pull the guide plates 52 to expanded or contracted positions on the expandable tool 50. In this embodiment, the cams 54 and cam bearings 58 are reciprocated in and out by the manipulation of an actuator 60. One example of an actuator 50 is depicted in FIGS. 11-15 in the form of a lead screw. However, other suitable actuators may be used to move the guide plates from a collapsed to a loaded position. Other actuators used to collapse or expand the guide plates include, but are not limited to, lead screws, pneumatic or hydraulic cylinders, air bladders or the use of centrifugal force from a spinning motion of the tool. In operation, composite materials comprising filaments/fibers and resin are wrapped onto the pre-loaded mandrel, such as the mandrel 50 disclosed in FIG. 11 and as described above, to create the shape of the strut or structural member. As illustrated in FIG. 12, the pre-loaded tool is partially expanded to a state wherein the guide plates 52 are substantially even with each other, thereby forming a suitable platform to wind the fiber/polymer composition. The tool or mandrel 50 is then expanded or loaded using mechanical action applied directly the guide plates by the actuator 50, such as a lead screw, pneumatic or hydraulic cylinders, air bladders or with the use of centrifugal force from a spinning motion of the tool, to create pressure from within, thereby pushing outward against the fiber/polymer composition. The outward motion and expanding of the tool as illustrated in FIG. 13 moves the guide plates 52 further outward from the pre-loaded position, thereby providing straightening of all of the wound up tapes and or fibers to orient the fibers in a straightened/linear fashion and to further load the fibers by creating an internally tension and pre-stressed layup prior to the curing cycle. Once the fiber/polymer composition has be loaded, it is then cured with one or more crosslinking agents or techniques as described above (e.g. UV, EB, chemical agents . . . ), thereby setting the composition and stabilizing the overall lattice structure. The lattice structure is next released and removed from the tool 50 by collapsing the tool 50 as depicted in FIG. 13. Finally, FIGS. 14 and 15 depict cross-sectional side views of the loaded and collapsed mandrels 50, respectively.

Further tooling configurations may include internal rotational mechanisms or a circular motion mandrel core as illustrated in FIGS. 16-18. In this further embodiment of an expandable manufacturing apparatus or mandrel 50, an expandable mandrel 50 in the pre-load position, as depicted in FIG. 16, includes a plurality of guide plates 52 connected to linear cams 54 that are operably adjoined to an actuator wheel 62 by one or more cam rollers 64 (e.g. bolts, lugnuts, or pins . . . ). The cam rollers 64 traverse within slots 66 positioned on the actuator wheel 62. In turning the wheel 62 in one direction the guide plates 52 move outward to a loaded configuration as depicted in FIG. 17 and in turning the wheel in the opposite direction, the guide plates 52 move inward to a collapsed position as depicted in FIG. 18. In operation, the open lattice composite matrix support structures may be produced on the expandable wheel mandrel as depicted in FIGS. 16-18 in a process similar to the process described in the previous paragraph when using the other expandable mandrel embodiment disclosed herein.

As previously mentioned, the open lattice composite matrix support structures of the present invention can be formed into a number of different configurations, shapes and sizes for use in devices (e.g. towers, poles, masts . . . ) used in various industries or fields including, but not limited to, renewable energy power production, energy/power transmission, telecommunications, surveillance, lighting, containment fencing, and antenna support. Other uses include, but are not limited to Wifi, cellular, microwave, satellite, UHF-VHF.

The lattice structures may be produced as unitary struts/members or may be produced as modular struts/members that may be adjoined to form the final lattice structure product. FIGS. 19 and 20 depict an embodiment of a lattice structure 68 of the present invention, wherein a cylindrical tower is formed using one or more cylindrical modular struts 70. In the embodiments found in FIGS. 19 and 20, the struts 70 are tapered so that a first end 72 is narrower than the second end 74. Such a tapered configuration allows for nesting of one strut 70 within an adjacent strut 70 by inserting the narrower first end 72 of one strut 70 into the wider end 74 of the adjacent strut 70. This allows for the lengthening or heightening of the tower 68 to create towers of varying height, as well as provides easy assembly during construction due to the modular nature of the tower 68. It is noted that the description regarding the components and processes to produce lattice structures or towers in this application can also be applied to the description of devices and processes for poles, masts and other structural support systems.

The lattice structures of the present invention may be formed in many configurations, shapes and sizes. For example, the lattice structures of the present invention could take a number of shapes, such as cylindrical, trapezoidal, polygonal, octagonal, hexagonal, triangular, or any other shape that may be molded into a lattice structure. FIGS. 21 and 22a-22b depict a lattice structure 68 that includes a single strut 70 in a trapezoidal configuration. As can be seen, the lattice structure 68 includes primary border members 21 that are adjoined to lateral members 12 and secondary border members 22 to form a trapezoid. It is noted that lateral members in this embodiment may also be considered secondary border members. Cross members 13 traverse between the primary border members 21 to form the trapezoidal lattice structure depicted in FIGS. 21 and 22a-22b.

FIGS. 23-26 depict other embodiments of the lattice structures of the present invention wherein the strut 70 takes the form of an octagonal tube or a hexagonal tube. In FIGS. 23a-23b and 25, the embodiments include an octagonal lattice structure that is formed with a plurality of primary border members 21, lateral border members 12 and secondary border members 22 to form a series of square patterns, thereby forming the octagonal structure. Alternatively, the hexagonal structure 68 depicted in FIG. 26a-26c includes a plurality of cross member to form the lattice structure. It is noted that a square pattern may also be used with the hexagonal tubular configuration. However, octagonal or hexagonal tubular structures may include other patterns utilizing cross members, longitudinal member, lateral members and other members disclosed herein. Another example of an alternative pattern is the diamond patter formed by cross members in FIG. 24.

In all of the various embodiments disclosed or suggested in the present application, support members may be interweaved or embedded in the lattice structure of the open lattice matrix support structures of the present invention. For example, FIGS. 25 and 26 depict a lattice structure of the present invention wherein a plurality of support members 76 (e.g. rods) are embedded within the lattice structure. Support members 76 may include one or more structural materials that assist in adding strength and stability to the overall lattice structure (e.g. tower, pole, mast . . . ). Examples of structural materials, include but are not limited to steel, aluminum, reinforced concrete, ceramics or any other solid material that adds additional strength and stability to the overall lattice structure. In various embodiments, the support members are used to enhance compressive strength of the overall structure. In various embodiments, the support members are positioned as a spacer between inner walls and outer walls of fiber/polymer composite material and the inner walls and outer walls are positioned to support the support members by keeping them straight under compressive load. This composite double wall configuration is used primarily to keep the support member straight for absorbing compressive load.

In yet another embodiment of the present invention, FIG. 27 depicts an embodiment wherein the lattice structure 68 is formed into a triangular tube. The lattice structure illustrated in this embodiment includes a plurality of primary border members 21 adjoined to a plurality of secondary border members 22 to form the borders of the triangular structure. Additional support is provided by including a series of lateral members 12 cross members 13 adjoined to the primary border members 21 and secondary border members 22.

Additional strength and stability may be provided in producing open lattice matrix support structures by interlocking a plurality of struts to form columns. FIGS. 28-31 depict various embodiments of columns 78 of the present invention that include different configuration of struts 70 (e.g. triangular, octagonal, trapezoidal, hexagonal . . . ) that are tied together to with a strut connector 80 to form an aggregated tower or column system 78. In operation, two or more struts 70 are positioned adjacent to each other and bound together with strut connectors 80 to form the aggregated column 78. As previously suggested, any strut configuration or shape may be used to form columns, such as triangular struts (FIG. 28), octagonal struts (FIGS. 29), hexagonal struts (FIG. 30) and trapezoidal struts (FIG. 31). However, it is noted that any shape strut may be used to form a column of the present invention. The strut connectors 80 may be any type of connection means to properly secure the individual struts together to form a secure column. For example, strut connectors that may be used in the present invention include, but are not limited to securing cables (e.g. polymeric, composite, rubber and/or metal cables), securing rods, clamps, rope systems or any other securing means or mechanism.

FIGS. 34-35 depict embodiments of telescoping structures (e.g. towers, masts . . . ) that include two or more open matrix composite struts adjoined with one or more interlocking connectors or friction securing nesting features. In various embodiments, the lattice support structure or “tower” is made to nest successive sections or struts inside of each other for ease of transport and quick deployment. FIG. 34 depicts a telescoping lattice structure 82 including three struts 70. The struts 70 of this embodiment are tapered to nest within the or accept within all or a portion of the adjacent strut 70. In various embodiments, the telescoping structures are held in a deployed position with releasable locking connectors or may be held in position through mechanical contact and friction with the larger sized end of an adjacent strut. FIG. 35 illustrates a fully erect and deployed cylindrical telescoping tower 82 with each successive section reducing in diameter from strut 70 to strut 70.

In further detail, referring to the embodiments of FIGS. 36-37, a self deploying and/or self erecting telescoping tower with the use of a mechanical or electro mechanical cable and pulley winching system is illustrated. The winching system depicted in FIGS. 36 and 37 includes one or more pulleys 84 operably connected to one or more cables 86. The use of composite cables, composite pulleys and an electrical or mechanical winch to draw the tower sections upward for hands free push deployment provides ease in raising and lowering the tower. In many embodiments a pulley 84 is positioned on each strut and is operably connected to one or more cables. Upon pulling a lead cable, force is applied to the upper strut thereby pulling the struts upward and extending the length of the tower 82 until the locking connector 80 between two adjacent struts 70 is engaged. The use of cables 86 and the tapered connectors 80 provide for ease in deploying and stabilizing an extended tower. A further interlocking connector can be used with mechanical locking actuated at the connector with a second set of cables attached to the system.

In yet other embodiments of the present invention pneumatics, hydraulics and/or mechanical force may be used to deploy the telescoping towers of the present invention. A further embodiment for a self erection system for the telescoping tower is a pneumatic pump and bladder. FIGS. 38-39 depict a self erection system that includes a pneumatic or hydraulic pump 88 that when engaged expands a bladder 90 positioned within the telescoping tower structure 82, thereby raising the tower 82 or lowering it. In operation, the bladder 90 is deflated and inserted inside the tower 82 and inflated with a pump 88. When the pump 88 is activated, the open matrix composite structure is raised by the increase in size of the bladder pushing upward the struts 70 of the tower structure; the bladder system is normally configured to raise the tower struts in succession. Another embodiment of the self erecting or self deploying mechanism FIGS. 38-39 used in conjunction with the open matrix composite telescoping tower is the use of a electro-mechanical, Hydraulic-mechanical or Pneumatic-mechanical actuated screw jack to raise the tower. In general, the lead screws are driven by a small gear box and draws the nuts affixed to the connectors that draws the tower up to deployment.

In various embodiments of the present invention, the open lattice composite matrix support structures include one or more lock or strut connectors to secure multiple struts together or to lock into place multiple struts that have been deployed in a telescoping structure. Many types of connectors may be implemented to adjoin struts in an lattice structure. FIGS. 40-42 depict embodiments of the present invention illustrate strut connectors 80 that include a connector member 92 having member body 94 including one or more pin apertures 96 adjoined to a flanged end 98. An end of a strut is generally configured to nest over or within the member body 94 and is further secured to the connector 80 by insertion of locking pins 100 into the pin apertures 96 positioned on the member body 94.

FIGS. 42 and 43 depict another embodiment of the lock connectors of the present invention. The lock connectors 80 illustrated in FIGS. 42 and 43 generally include a female connector member 92 and a male connector member 102. The female connector member 92 includes female member body 94 having one or more raised thread patterns 106 extending outward from the female member body 94. The male connector member 102 includes a male member body 104 that is sized slightly smaller than the female member body and also includes one or more raised thread patterns 106 extending outward from the member body 94. The female and/or male member bodies 94, 104 may also be adjoined to a flanged end 98. In operation, an end of a strut is generally configured to nest over and be secured on the member body 94 of the female member 92 and an adjacent strut is configured to nest within and be secured to the interior of the male member body 104. Once the two struts are secured in their respective connector member, they can be secured together as depicted in FIG. 43 by inserting the male member body 94 into the female member body 94 and turning the male and/or female housings until the thread patterns of each come in contact and interlock with each other.

FIGS. 44-46 depict yet other types of lock connector embodiments that may be used in the lattice structures of the present invention. Similar to the thread connectors described in the previously paragraph, the connectors illustrated in FIGS. 44-46 include male and female connector members 92,102. The difference is in the connection mechanism, wherein the male member body 104 includes one or more raised platforms 108 that slides upon turning into a slot (not shown) positioned within the female member body 94, thereby locking the two connector members together.

FIG. 47 depicts another embodiment of the lock connectors of the present invention, which is similar to the embodiments depicted in FIGS. 42 and 43. The lock connector 80 illustrated in FIG. 47 generally includes a female connector member 92 and a male connector member 102. The female connector member 92 includes a female member body 94 having one or more raised thread patterns 106 for receiving the raised thread patterns 106 extending from the male member body 104. The male connector member 102 includes a male member body 104 that is sized slightly smaller than the female member body and includes one or more raised thread patterns 106 extending outward from the member body 94. It is noted that the male and/or female bodies 94, 104 are tapered in this embodiment, thereby providing for ease in securing the two bodies together and for a more stable connection to the strut members being adjoined. The female and/or male member bodies 94, 104 may also be adjoined to a flanged end 98. In operation, an end of a strut is generally configured to nest over and be secured on the member body 94 of the female member 92 and an adjacent strut is configured to nest within and be secured to the interior of the male member body 104. Once the two struts are secured in their respective connector member, they can be secured together by inserting the male member body 94 into the female member body 94 and turning the male and/or female housings until the thread patterns 106 of each come in contact and interlock with each other.

FIGS. 48-50 depict another embodiment of a lock connector that may be utilized with the modular strut lattice structures of the present invention. FIG. 48 depicts a lock connector 80 comprising an upper section 110 and lower section 112 divided by a retaining platform 114. The upper and lower sections 110, 112 contain a plurality of apertures for accepting fasteners for accepting a plurality of locking lugs 116. The lock connector 80 of this embodiment may further include a slit 118 (e.g. a helical slit) for expanding the lock connector 80, thereby fitting it tightly with the struts 70 that are nested over the upper and lower sections 110, 112. See the slit In securing the struts 70, a strut 70 is applied over the upper section 110 of the connector 80 until it extends down to the retaining platform 114. Next another strut 70 is applied over the lower section 112 and extends up to the lower surface of the platform 114. The connector is then expanded so that the surface of the connector snuggly contacts the inner surface of each strut 70. The struts 70 are then secured to the connector 80 with one or more lock lugs 116. In various embodiments the lock lugs 116 are generally shaped like the strut apertures in the lattice structure; however they are normally sized a little larger than the strut apertures.

In further detail, referring to the invention of FIGS. 51-53, the lattice support structures of the present invention are easily and securely anchored or mounted to virtually any surface. FIGS 51-53 depict embodiments of lattice structure T-bar anchors or mounts. The T-bar anchors generally comprise a lattice housing 120 configured to receive and secure a strut 70. The housing 120 includes a housing body 122 that includes one or more housing extensions 124 having one or more apertures for receiving a T-bar 126; the T-bar provides the connection and releasable feature for the anchor. Alternatively, the housing 120 may include apertures bored through the housing body 122 as depicted in FIG. 54. Such a structure allows for a T-bar 126 to pass through the housing body 122, thereby securing the housing to the rest of the anchor. The anchor further includes a bracket 128 having a bracket housing 130 including one or more bracket extensions 132 having one or more apertures for receiving and securing the T-Bar 126 thereby securing the lattice support structure to the anchor. In an alternative embodiment, as depicted in FIG. 52, the strut may be secured directly to the bracket with the T-bar rather than using a lattice housing. The anchor further includes a base 134 that provides a platform for securing the lattice structure to a surface, such as concrete, wood, earth or any other desired surface. Embodiments of the anchor used with the lattice structures of the present invention may further include a hinge 136 that allows for the swivel or dropping of lattice structure.

FIG. 55 depicts another mounting or anchoring device that may be used to anchor the lattice structures of the present invention. The mount or anchor depicted in FIG. 55 comprises a base 134 adjoined to a bracket 130 that is operably connected to a flange mount 138. The flange mount 138 include a lattice structure insert body 140 adjoined to an abutment flange 142. In operation, the insert body 140 is insert into the lumen of a strut 70 until the proximal end of the strut comes in contact with the flange 142. Next, if the strut 70 is not adequately secured to the flange mount 138 through sufficient frictional contact between the strut 70 and flange 138, it may be necessary to further secure the mount 138 to the strut 70 using one or more fasteners means, such as clips, screws, lugs, adhesives or any other suitable fastening means.

The lattice structures of the present invention may be stably secured to the earth using one or more different anchoring processes or devices. For example, the lattice structures may be secured to the earth using concrete, burying a portion of the lattice structure base, buried anchoring poles and devices, pier systems (e.g. helical pier systems, push pier systems, slab pier systems . . . ). One embodiment of an anchoring system that may be used with the lattice structures of the present invention is a helical pier system. In such embodiments as depicted in FIGS. 56-59, the helical pier system comprises a strut 70 mounted to an anchor that includes a lattice housing 120 adjoined to a bracket 128 connected to a base 134. A securing rod 144 is adjoined to a helical pier 146, wherein the rod 144 extends through the base 134 and up into the bracket 128 of the anchoring device. In operation, the helical pier 146 is driven into the earth and the lattice structure and the mounting anchor, including the lattice housing 120, bracket 128 and base 134, are secured to the helical pier, thereby securing the lattice structure into the desired position. It is noted that the base 134 may include a plurality of plates 148 and a base hinge 150 for ease in laying down and raising up the lattice structure. In various embodiments, as depicted in FIGS. 58-59, the lattice housing may be tapered to effectively receive and retain a strut 70. It is also noted that in many embodiments, regardless of anchoring device, the support structure or “tower” may require rigging or guy lines to completely secure the structure. It is further noted that, the construction of the connectors and anchoring and/or mounting systems used in the present invention can be made of a fiber reinforced machined or injection molded plastic. These connectors and anchoring and/or mounting systems may also be machined or cast from any metal for example aluminum or steel. However, any stable material may be used.

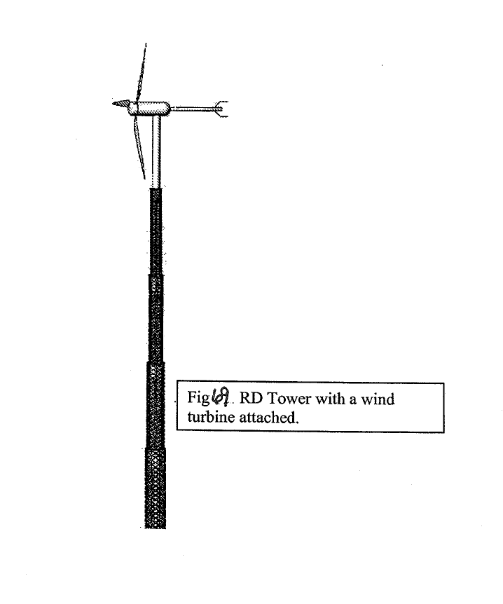

As is evident, there are many applications for the open lattice composite matrix support structures of the present invention. A number of such applications are suggested throughout the specification, but FIGS. 60-69 illustrate a few such applications. For example, FIG. 60 depicts a power pole 160 formed of the lattice structures of the present invention. FIGS. 61-63 illustrate a telescoping tower 82 supporting a solar panel attachment, solar panel and communications disc 166. Additionally, FIGS. 64-68 depict other video, surveillance, microwave, satellite and telecommunications applications that can be supported by the lattice structures of the present invention. Finally, the tower, mast or lattice support structure of the present invention can be used as a wind turbine support structure as illustrated in FIG. 69 for small medium and large scale wind turbines.

While the foregoing written description and drawings of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A lattice composite matrix support structure comprising:
one or more struts including a plurality of fiber/polymer members that have a plurality of filaments and/or fibers and one or more polymeric materials, the members layered in an interweaved configuration that intersect at a plurality of nodes to form the struts;
the plurality of fiber/polymer members and the filaments or fibers of the fiber/polymer members are set into a stabilized position by embedding them within the one or more polymeric materials upon curing of the polymeric materials;
the filaments and or fibers preloaded in a substantially aligned, straightened and/or tensioned state by application of outward expansion pressure to the lattice structure prior to and/or during curing of the polymeric materials.

2. The lattice structures of claim 1, wherein the polymeric materials are radiation cured polymeric materials.

3. The lattice structures of claim 2, wherein the radiation cured polymeric materials are polymeric materials that are cured with one or more radiation sources selected from the group consisting of Ultraviolet (UV), Infrared (IR), Electron Beam (EB or E-beam) and X-ray.

4. The lattice structures of claim 1, wherein the outward expansion pressure is applied by using an expandable apparatus.

5. The lattice structures of claim 1, wherein the outward expansion pressure is achieved by applying rotational centrifugal force.

6. The lattice structures of claim 4, wherein the members are positioned in the lattice structure by curing the fiber/polymer members while placed within channels on the expandable manufacturing apparatus.

7. The lattice structures of claim 4, wherein the members are positioned in the lattice structure by curing the fiber/polymer members while placed on point to point locations raised above the apparatus surface to suspend the fibers in atmosphere under tension.

8. The lattice structures of claim 1, including two or more struts that are adjoined using one or more connectors.

9. The lattice structures of claim 8, wherein each strut is sized to nest within or receive within one or more other adjoining struts, the struts also being adjoined with connectors that are adapted to allow the adjoining struts to telescope to and from collapsed to expanded states to form a telescoping support structure.

10. The lattice structures of claim 9, wherein the telescoping support structure includes systems to manually or automatically deploy said telescoping structures to and from collapsed to expanded states.

11-13. (canceled)

14. The lattice structures of claim 9, wherein the telescoping support structure is deployed with a electromechanical or manual winching cable system for automatic tower erection with the force applied through cable tension.

15. The lattice structures of claim 14, wherein the cable pulling tension on the struts forces tapered or interlocking connectors to interact and stay rigid.

16. The lattice structures of claim 9, wherein the telescoping support structure is deployed with a pneumatic bladder or other pneumatic actuating system applying mechanical force to raise the telescoping structure.

17. (canceled)

18. The lattice structures of claim 9, wherein the telescoping support is deployed with a hydro-mechanical, pneumatic-mechanical, or electro-mechanical screw jack mechanism for deployment.

19. (canceled)

20. The lattice structures of claim 1, wherein the lattice structure is deployed with a Helical pier foundation system.

21. The lattice structures of claim 1, wherein individual lattice structures can be interlocked or affixed through mechanical means to form a structure of a combination of multiple lattice structures to form one large column structure.

22. The lattice structures of claim 1, wherein the polymeric materials are cured with one or more chemical agents.

23-38. (canceled)

39. An expandable tool for producing a lattice composite matrix support structure comprising a plurality of guide plates connected to one or more linear cams; the linear cams are operably adjoined to one or more cam bearings and are secured and guided by one or more cam guides; the linear cams and cam bearings are configured to push or pull the guide plates to expanded or contracted positions on the expandable tool; the cams and cam bearings are reciprocated in and out by the manipulation of an actuator 60.

40. The expandable tool of claim 39 wherein the actuator is selected from the group consisting of a lead screw, pneumatic or hydraulic cylinders, air bladders or the use of centrifugal force from a spinning motion of the tool.

41. A method of producing a lattice composite matrix support structure comprising:
winding a plurality of fiber/polymer members around an expandable mandrel to form a closed lattice structure that includes the crossing of multiple members to produce a plurality of nodes;
the fiber/polymer members including a plurality of filaments and/or fibers and one or more polymeric materials;
expanding the mandrel to a loaded position preloading the members to align, straighten and/or produce tension of the filaments and/or fibers present in the member;
curing the polymer to set the structure of the lattice support structure; and
collapsing the mandrel to release and remove the lattice structure from the mandrel.

42-77. (canceled)
